(19) United States
(12) Patent Application Publication
(10) Pub. No.: US 2008/0193755 A1
(43) Pub. Date: Aug. 14, 2008

(54) EXTRUSION DIE, METHODS OF COATING A WIRE CORE, AND A COATED WIRE BY THE EXTRUSION DIE AND METHODS

(76) Inventors: Olivier Guise, Albany, NY (US); Xin Kong, Shanghai (CN); Xiucuo Li, Shanghai (CN); James J. Xu, Niskayuna, NY (US); Weiguang Yao, Moka shi (JP)

Correspondence Address: CANTOR COLBURN LLP - SABIC (NORYL), 20 Church Street, 22nd Floor, Hartford, CT, 06103, US

(21) Appl. No.: 11/672,974

(22) Filed: Feb. 9, 2007

(51) Int. Cl. B32B 15/08

(52) U.S. Cl. 428/379; 118/234; 174/110 SR; 264/172.19; 264/40.1

(57) ABSTRACT

This disclosure relates to a coated wire, an extrusion die, a process of coating a wire and a method of testing wrinkles on covering of a coated wire. A coated wire comprises a wire core; and a covering comprising a thermoplastic composition which comprises by weight of total composition, (i) 10% to 50% of a poly(arylene ether); (ii) 5% to 25% of a polyolefin; and (iii) 15% to 45% of an impact modifier. The wrinkles presented on the covering of a coated wire manufactured by an extrusion die are substantively reduced.

### BACKGROUND OF INVENTION

This disclosure relates to an extrusion die, an extrusion equipment comprising the extrusion die, a method of coating a wire core, a coated wire and a method of testing wrinkles on the covering of the coated wire.

Polyvinyl chloride resins have long been used as an electrically insulating thermoplastic covering in the coated wire and cable industry. There is mounting concern over the environmental impact of halogenated materials and non-halogenated alternatives are being sought. This search has met with some success in polyethylene compositions and a thermoplastic composition comprising poly(arylene ether). However, as much of the wire coating extrusion equipment was created based upon the specifications of halogenated resins such as polyvinyl chloride, coated wires with replacement materials have problems in being handled in a manner similar to the halogenated resins. Wires or cables with a covering of halogenated resins are generally smooth on the surface, without any wrinkles, even in bent form. However, coating wire with a thermoplastic composition comprising poly(arylene ether) by the prior extrusion equipment has high levels of wrinkles, especially in bent form, that can result in deterioration of properties.

Additionally, as electronic devices become increasingly smaller and transportable there is an increasing need for the wires and cables employed as part of accessories for these devices to be more flexible and durable. Flexibility and durability for non-halogenated covering made by the prior extrusion equipment can be difficult to achieve, particularly in harsh environments.

Efforts were made to use processing method or equipment to resolve wrinkle issue. Moreover, the optimal processing for the material has been done. However, no progress was made to remove this wrinkle issue.

Accordingly, there is a need for a coated wire with excellent mechanical properties and processability, which is important to the durability and cost effectiveness of coated wires and cables made using the replacement materials for halogenated resins.

There is also a need for a new extrusion die that can reduce and/or eliminate wrinkles appearing on the inner side of the bent portion of the manufactured wire, and at the same time, keep other wire and cable performance.

### BRIEF DESCRIPTION OF THE INVENTION

The above described needs can be met by the embodiments as below:

In one embodiment, an extrusion die for manufacturing coated wire comprising an inner die 440 and an outer die 410,

wherein the inner die 440 comprises a wire core passing space 442 and a projection end 446 having a length (C);

wherein the outer die 410 comprises an inner space 412 and an exit passage 416;

wherein the projection end 446 of the inner die 440 is positioned at least partially within the inner space 412 and exit passage 416 of the outer die 410 to form a wire coating passage 432 and a molding passage 436.

In one embodiment, an extrusion equipment comprising an extrusion die comprising an inner die 440 and an outer die 410, wherein the inner die 440 comprises a wire core passing space 442 and a projection end 446 having a length (C); wherein the outer die 410 comprises an inner space 412 and an exit passage 416; and wherein the projection end 446 of the inner die 440 is positioned at least partially within the inner space 412 and exit passage 416 of the outer die 410 to form a wire coating passage 432 and a molding passage 436;

and one or more of the following:

wherein the average ratio of the length (A) of the molding passage 436 to the average inner width (Y) of the exit passage 416 is 0.2 to 3;

wherein the average ratio of the average outer width (X) of the projection end 446 of the inner die 440 to the average inner width (Y) of the exit passage 416 of the outer die 410 is 0.4 to 0.95;

wherein the projection end 446 of the inner die 440 has a length (D) that is positioned outside the exit passage 416 of the outer die 410;

wherein the average ratio of length (D) to the average outer width (X) of projection end 446 of the inner die 440 is 0.2 to 3;

wherein the projection end 446 of the inner die 440 has a cylindrical shape;

wherein the average outer width (X) is the average outer diameter of the projection end 446;

wherein the exit passage 416 of the outer die 410 has a cylindrical shape;

wherein the average inner width (Y) is the average inner diameter of the exit passage 416; and

wherein the die comprises more than one inner die and more than one outer die.

In another embodiment, a method for reducing wrinkles on the covering of a coated wire wherein the method comprises extrusion coating a thermoplastic composition onto a wire core wherein the extrusion coating comprises use of a die of the present invention.

In another embodiment, a method of coating a wire core comprises the steps of:

(a) melting a thermoplastic composition to form a melt thermoplastic composition which comprises by weight of the total composition: (i) 10% to 50% of a poly(arylene ether); (ii) 5% to 25% of a polyolefin; and (iii) 15% to 45% of an impact modifier;

(b) optionally filtering the melt thermoplastic composition to form a filtered composition;

(c) coating the filtered composition onto a wire core; and

(d) molding the coated wire (Y) for an length (A).

In another embodiment, a method of for reducing wrinkles on the covering of a coated wire comprises the steps of:

(a) melting a thermoplastic composition to form a melt thermoplastic composition which comprises by weight of the total composition: (i) 10% to 50% of a poly(arylene ether); (ii) 5% to 25% of a polyolefin; and (iii) 15% to 45% of an impact modifier;

(b) optionally filtering the melt thermoplastic composition to form a filtered composition;

(c) coating the filtered composition onto a wire core; and

(d) molding the coated wire (Y) for an length (A).

In one embodiment, a method of coating a wire core by an extrusion die of the present invention comprises the steps of:

(a) melting a thermoplastic composition to form a melt thermoplastic composition which comprises by weight of the total composition: (i) 10% to 50% of a poly(arylene ether); (ii) 5% to 25% of a polyolefin; and (iii) 15% to 45% of an impact modifier;

(b) optionally filtering the melt thermoplastic composition to form a filtered composition;

(c) coating the filtered composition onto a wire core in the wire coating passage 432; and

(d) molding the coated wire in the molding passage 436.

In one embodiment, a method of coating a wire core by an extrusion die comprising an inner die 440 and an outer die 410, wherein the inner die 440 comprises a wire core passing space 442 and a projection end 446 having a length (C); wherein the outer die 410 comprises an inner space 412 and an exit passage 416; and wherein the projection end 446 of the inner die 440 is positioned at least partially within the inner space 412 and exit passage 416 of the outer die 410 to form a wire coating passage 432 and a molding passage 436, comprises the steps of:

(a) melting a thermoplastic composition to form a melt thermoplastic composition which comprises by weight of the total composition: (i) 10% to 50% of a poly(arylene ether); (ii) 5% to 25% of a polyolefin; and (iii) 15% to 45% of an impact modifier;

(b) optionally filtering the melt thermoplastic composition to form a filtered composition;

(c) coating the filtered composition onto a wire core in the wire coating passage 432; and

(d) molding the coated wire in the molding passage 436.

In one embodiment, a method for reducing wrinkles on the covering of a coated wire by an extrusion die of the present invention, comprises the steps of:

(a) melting a thermoplastic composition to form a melt thermoplastic composition which comprises by weight of the total composition: (i) 10% to 50% of a poly(arylene ether); (ii) 5% to 25% of a polyolefin; and (iii) 15% to 45% of an impact modifier;

(b) optionally filtering the melt thermoplastic composition to form a filtered composition;

(c) coating the filtered composition onto a wire core in the wire coating passage 432; and

(d) molding the coated wire in the molding passage 436.

In another embodiment, a coated wire comprises a wire core and a covering comprising a thermoplastic composition,

wherein the coated wire is made by a method of any one of the present invention.

In another embodiment, a coated wire comprising a wire core and a covering comprising a thermoplastic composition, wherein the coated wire is made by a method of extrusion coating a wire core by an extrusion die of the present invention; and

wherein the thermoplastic composition comprises by weight of the total composition: (i) 10% to 50% of a poly(arylene ether); (ii) 5% to 25% of a polyolefin; and (iii) 15% to 45% of an impact modifier.

In another embodiment, a coated wire comprises a wire core and a covering comprising a thermoplastic composition,

wherein the coated wire is coated by a method comprising the steps of (a) melting a thermoplastic composition to form a melt thermoplastic composition; (b) optionally filtering the melt thermoplastic composition to form a filtered composition; (c) coating the filtered composition onto a wire core; and (d) molding the coated wire for a length;

wherein the thermoplastic composition comprising by weight of the total composition: (i) 10% to 50% of a poly(arylene ether); (ii) 5% to 25% of a polyolefin; and (iii) 15% to 45% of an impact modifier.

In another embodiment, a coated wire comprises a wire core and a covering comprising a thermoplastic composition,

wherein the coated wire is manufactured by an extrusion die comprising an inner die 440 and an outer die 410, wherein the inner die 440 comprises a wire core passing space 442 and a projection end 446 having a length (C); wherein the outer die 410 comprises an inner space 412 and an exit passage 416; wherein the projection end 446 of the inner die 440 is positioned at least partially within the inner space 412 and exit passage 416 of the outer die 410 to form a wire coating passage 432 and a molding passage 436; and

wherein the thermoplastic composition comprises by weight of the total composition: (i) 10% to 50% of a poly(arylene ether); (ii) 5% to 25% of a polyolefin; and (iii) 15% to 45% of an impact modifier.

In another embodiment, a coated wire comprises a wire core; and a covering comprising a thermoplastic composition,

wherein the thermoplastic composition comprising by weight of the total composition: (i) 10% to 50% of a poly(arylene ether); (ii) 5% to 25% of a polyolefin; and (iii) 15% to 45% of an impact modifier;

wherein the coated wire is make by the die of present invention and

wherein the coated wire has reduced wrinkles on the covering and the wrinkles have a ratio of wrinkle depth to outer diameter of the coated wire of less than 1 when the coated wire is bent.

In another embodiment, a coated wire comprises a wire core; and a covering comprising a thermoplastic composition,

wherein a thermoplastic composition comprises by weight of the total composition: (i) 10% to 50% of a poly(arylene ether); (ii) 5% to 25% of a polyolefin; and (iii) 15% to 45% of an impact modifier;

wherein the coated wire is made by the die of present invention and

wherein the coated wire is free of Type I wrinkles.

In another embodiment, a coated wire comprises a wire core; and a covering comprising a thermoplastic composition,

wherein a thermoplastic composition comprises, by weight of the total composition: (i) 10% to 50% of a poly(arylene ether); (ii) 5%-25% of a polyolefin; and (iii) 15% to 45% of an impact modifier;

wherein the coated wire is made by the die of present invention; and

wherein the coated wire is free of Type II wrinkles.

In another embodiment, a coated wire of the present invention, wherein the coated wire is free of Type I and Type II wrinkles.

In another embodiment, a method of testing wrinkles of a coated wire when the coated wire is bent, comprises the steps of

(i) setting a bending length from point 1 to point 2 on a coated wire;

(ii) bending the wire to bring the point 1 and point 2 being contact;

(iii) determining a bending angle α between [AB] and [AC] wherein point A is located at the top of the bent samples while the distance between points B and C defines the maximum width of the bent samples; and

(iv) measuring wrinkles in depth from the lowest point of surface of the coated wire to the top of the surface of the coated wire at the bending angle;

wherein a ratio of the bending length to outer diameter of a coated wire at a range of from 5 to 20; and

wherein the bending angle is of from 50 to 120 degree.

### BRIEF DESCRIPTION OF THE DRAWINGS

The foregoing and other aspects and advantages of the present invention will become more apparent and better understood by describing in detail exemplary embodiments thereof with reference to the attached drawings in which:

FIGS. 1(a) and 1(b) illustrate examples of single-core wire and multiple-core wire, respectively. In FIGS. 1(a) and 1(b), the number “2” represents a wire core; the number “4” represents a covering adjacent to the wire core; and the number “6” represents an outer covering.

FIGS. 2(a), 2(b) and 2(c) illustrate a conventional type of extrusion die; wherein the number “300” represents a conventional extrusion die; 310 represents an outer die; the number “340” represents an inner die; and the number “330” represents a supplying passage between the outer die 340 and the inner die 330.

FIGS. 3(a), 3(b) and 3(c) illustrate an extrusion die according to a preferred embodiment of the present invention.

FIGS. 4(a) and 4(b) are photographs showing wires after bending, which are manufactured by the extrusion die of present invention and the conventional die shown in FIG. 2, respectively.

FIG. 5(a) is a photograph showing the distance between point 1 and point 2; FIG. 5(b) is a photograph showing that point 1 and point 2 are brought together by bending the wire.

FIG. 6 shows the bending angle α.

FIG. 7(a) is an optical microscope image showing the measurement for the density of wrinkles; and FIG. 7(b) is an optical microscope image photograph showing measurement of wrinkles in depth from the lowest surface to the top of the surface of the coated wire at a bending angle.

FIG. 8 illustrates a sketch Figure for measuring wrinkles in depth from the lowest surface point of a coated wire to the top of a wrinkle when the coated wire is bent.

### DETAILED DESCRIPTION

In this specification and in the claims, which follow, reference will be made to a number of terms which shall be defined to have the following meanings.

The singular forms “a,” “an,” and “the” include plural referents unless the context clearly dictates otherwise.

“Optional” or “optionally” means that the subsequently described event or circumstance may or may not occur, and that the description includes instances where the event occurs and instances where it does not.

The endpoints of all ranges reciting the same characteristic are independently combinable and inclusive of the recited endpoint. Values expressed as “greater than” or “less than” are inclusive the stated endpoint, e.g., “greater than 3.5” encompasses the value of 3.5.

As used herein, the term “wrinkle(s)” is defined as those recurring protruding ridge patterns on the surface of the covering on the coated wire when the coated wire is bent, which is perpendicular to the direction of the wires or cables or extruding strand samples.

As used herein, the term “bent” is defined as bending a coated wire to have a bending angle.

As used herein, the term “a bending angle” is defined as an angle α formed between [AB] and [AC] when points 1 and 2 on a wire are brought together, wherein point A is located at the top of the bent sample while the distance between points B and C defines the maximum width of the bent sample. Generally, the bending angle ranges from 50 to 120 degree.

As used herein, two types of wrinkles, “Type I wrinkles” and “Type II wrinkles” occur when the coated wire is bent.

As used herein, “Type I wrinkles” are defined as those typically related to poor adhesion between covering materials and inside wire cores. Type I wrinkles are few but are relatively large in dimensions.

As used herein, “Type II wrinkles” are fine-structured ones which are generally related to the characteristics of the materials and structures of coated wires. The Type II wrinkles can be readily correlated to extruding wire samples. It is found that the absence of Type II wrinkles is generally associated with the absence of Type I wrinkles.

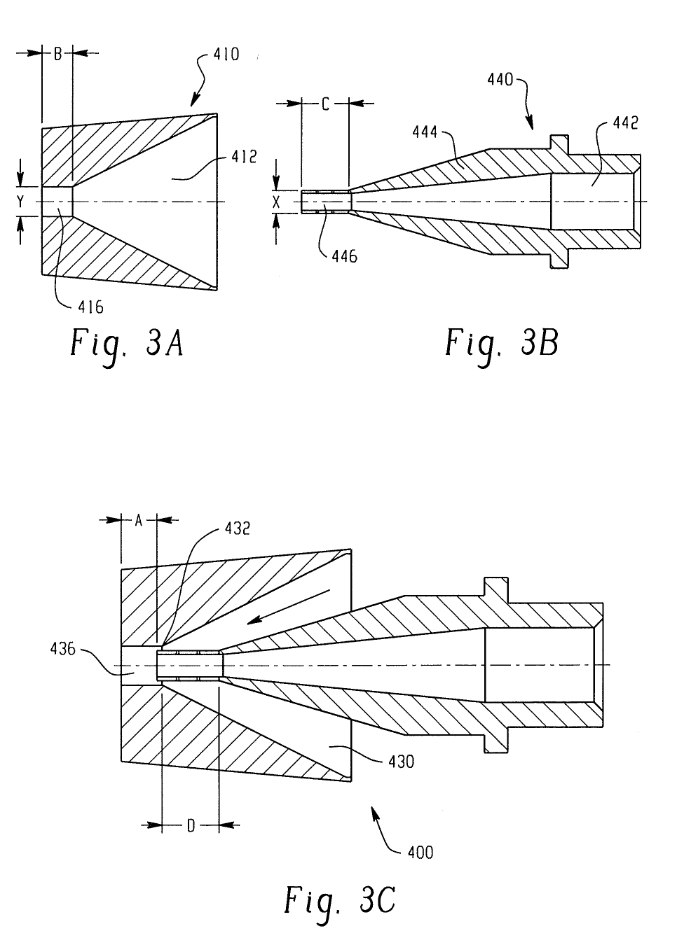

As used herein, the term “width (X)” and “width (Y)” represent a value of height measured for passages of dies or coated wires as indicated in FIG. 3 according to the cross sectional view along machine direction thereof.

### Extrusion Equipment

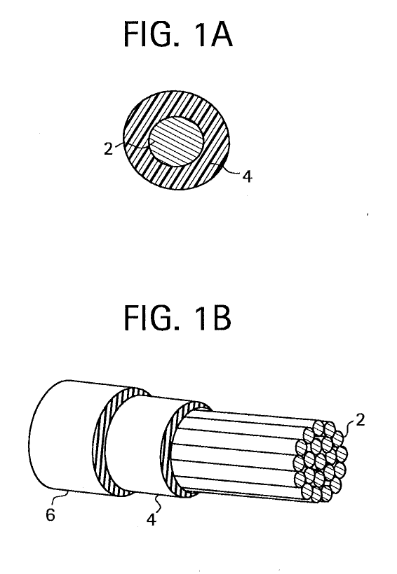

An extrusion equipment comprises an extrusion die and other members including, but not limiting to, a screw, crosshead, breaker plate, distributor, or nipple. The extrusion equipment is useful for manufacturing a coated wire, e.g. by coating an insulation material such as plastic to a wire core (see, e.g., FIG. 1). The key component of the extrusion equipment is an extrusion die, which coats a molten thermoplastic composition onto the wire core that is passing through the extruding die.

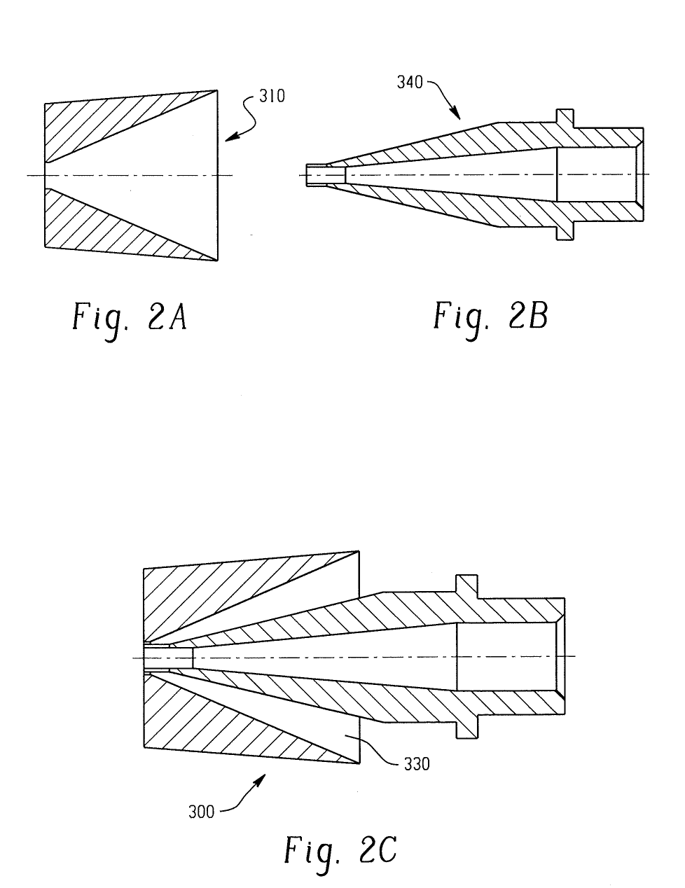

FIG. 2 shows a conventional extrusion die (the prior art extrusion die) 300 for manufacturing a PVC-coated wire. In FIG. 2, the die 300 comprises an inner die 310 and an outer die 340. In operation, the inner die 340 is positioned into the inner space of the outer die 310 with a distance between the front surface of the opening of the inner die 310 and the front surface of the opening of the outer die 340 is ˜0, as shown in FIG. 2(c). In some cases, the front surface of the opening of the inner die 310 may be shorter, e.g., 1 mm, than the front surface of the opening of the outer die 340. The gap 330 between the inner die 340 and the outer die 310 acts as a passage for injecting molten poly(vinyl chloride) (PVC) material. The molten PVC material under predetermined pressure passes through the gap 330, and then is substantially uniformly coated onto the wire core which passes through the central hole of the inner die 340.

FIG. 3 illustrates one embodiment of an extrusion die 400 of the present invention.

The die 400 comprises an inner die 440 and an outer die 410. The inner die 440 comprises a wire core passing space 442 and a projection end 446 having a length (C). The outer die 410 comprises an inner space 412 and an exit passage 416 with a length (B). The projection end 446 of the inner die 440 is positioned at least partially within the exit passage 416 of the outer die 410 to form a wire coating passage 432 between the outer surface of the projection end 446 and inner surface of the exit passage 416 having a length of (C-D) and a molding passage 436 with a length (A).

In one embodiment, a molding passage can be added to a conventional extrusion die used in the extrusion coating equipment so as to improve the appearance and performance, e.g. wrinkles appeared on internal wire surface when the coated wire is bent.

In one embodiment, a die (see e.g., FIG. 3) for manufacturing a coated wire comprises an inner die 440 and an outer die 410, wherein the inner die 440 comprises a wire core passing space 442 and a projection end 446 having a length (C); wherein the outer die 410 comprises an inner space 412 and an exit passage 416; and wherein the projection end 446 of the inner die 440 is positioned at least partially within the inner space 412 and exit passage 416 of the outer die 410 to form a wire coating passage 432 and a molding passage 436.

A supplying passage 430 is formed between outer surface of the inner die 440 and the inner surface of the outer die 410 as a gap (space) for allowing a molten coating composition to flow onto a wire core when the inner die 440 is partially trapped into the inner space 412 of the outer die 410.

In one embodiment, an extrusion die for manufacturing a coated wire comprises a cylindrical molding passage with a length (A), through which the coated wire passes and at an inner end of which an outlet of a material supplying passage is formed, whereby a wire core is coated by a thermoplastic composition supplied out of the material supplying passage and the coated wire passes the molding passage out of the extrusion die.

The die 400 will now be illustrated in detail with reference to FIG. 3(a)-3(c).

As shown in FIG. 3(a), the outer die 410 has a truncated conical inner space (conical cavity) 412, and an exit passage 416 having an inner width (Y) and a length (B).

As shown in FIG. 3(b), the inner die 440 contains a wire core passing space 442, a conical front end 444, and a projection end 446 formed at one end of the conical front end 444 with a smaller diameter, wherein the projection end 446 has a length (C) and an outer width (X). When a wire core passes through the projection end 446 along the axial direction of the projection end 446, an outlet on the side face of the projection end 446 is formed.

As shown in FIG. 3(c), a wire coating passage 432 and a molding passage 436 are formed when the conical front end 444 and the projection end 446 thereon are at least partially inserted into the inner space 412 of the out die 410, and the projection end 446 is at least partially positioned within the exit passage 416. The projection end 446 of the inner die 440 has a length (D) that is positioned outside the exit passage 416 of the outer die 410. Since the outer width (X) of the projection end 446 is smaller than the inner width (Y) of the exit passage 416, the gap there between forms a wire coating passage 432. The wire coating passage 432 is to impart a covering to a wire core with a thickness of (Y-X) and a length of (C-D). The molding passage 436 is formed from the outlet of the projection end 446 of the inner die 440 to outlet of the exit passage 416 of the outer die 410 and has a length (A). The molding passage 436 has an inner width (Y) also, through which the coated wire continues to pass and the covering on the wire core is more strongly adhered to the wire core and molded into final shape. In other words, the molding passage 436 is a portion of the exit passage 416. The length A could be determined in accordance with the thermoplastic composition to be coated, the size of the wire core and thickness of the covering.

The length (A) for molding the coated wire varies depending on outer width (Y) of a coated wire.

In one embodiment, the length (A) for molding the coated wire is generally more than 2 mm, preferably more than 4 mm. Preferably, the length (A) is less than 30 mm, preferably less than 20 mm, more preferably less than 15 mm, even more preferably less than 10 mm, even more preferably less than 8 mm, most preferably less 6 mm.

In one embodiment, the average ratio of the length (A) of the molding passage 436 to the average inner width (Y) of the exit passage 416 is 0.2 to 3, preferably 0.8 to 2, more preferably 1 to 1.5.

As described above, the supplying passage 430 for injecting the molten coating material is formed between the inner die 440 and the outer die 410. The size of the cross-section of the wire coating passage 432 is determined by the difference between the outer width (X) of the projection end 446 and the inner width (Y) of the exit passage 416, and thereby the flow of the molten thermoplastic composition can be controlled. The average ratio of the average outer width (X) of the projection end 446 of the inner die 440 to the average inner width (Y) of the exit passage 416 of the outer die 410 is 0.4 to 0.95, preferably 0.5 to 0.8.

In one embodiment, a taper (size of the vertex angle of a cone) of the conical front end 444 of the inner die 440 is smaller than or equal to, and preferably smaller than that of the conical inner space 412 of the outer die 410, so that the gap (space) between the inner die and the outer die has a cross section that is gradually reduced along the flowing direction (the direction of injection) of the molten molding materials.

The length (D) of the projection end 446 lying outside the exit passage 416 composes a part of the supplying passage, and the size of the supplying passage is determined to a certain degree by that of D. An average ratio of length (D) to the average outer width (X) of projection end 446 of the inner die 440 is 0.2 to 3, preferably 0.75 to 2.

The shape of the exit passage 416 and the projection end 446 depends on the end use of the coated wire. Generally, the exit passage 416 and the projection end 446 have cylindrical shape.

The size of the outer width (X) and the inner width (Y) varies depending on the wire core to be coated.

In one embodiment, the projection end (446) of the inner die (440) has a cylindrical shape. The outer width (X) is the outer diameter of the projection end 446. The average outer width (X) is the average outer diameter of the projection end 446.

In one embodiment, the exit passage (416) of the outer die (410) has a cylindrical shape. The inner width (Y) is the inner diameter of the exit passage (416). The average inner width (Y) is the average inner diameter of the exit passage (416).

In one embodiment, the average ratio of the length (A) of the molding passage (436) to the average inner diameter (Y) of the exit passage (416) is 0.2 to 3, preferably 0.8 to 2, more preferably 1 to 1.5.

In one embodiment, the average ratio of the average outer diameter (X) of the projection end (446) of the inner die (440) to the average inner diameter (Y) of the exit passage (416) of the outer die (410) is 0.4 to 0.95, preferably 0.5 to 0.8.

The operation process for coating wire core by an extrusion equipment having the die 400 will be described briefly thereafter.

During the process of coating a wire core, the wire core is pulled by a retractor (not shown) to continuously move through the wire passing space 442 of the inner die 440 so as to exit through the projection end 446 and then pass through the molding passage 436 of the outer die 410. Herein the wire core can comprise one bare wire, e.g., a metal wire, to be coated shown in FIG. 1(a), and can further comprise multiple conductive wires after preliminary coating shown in FIG. 1(b), in which the multiple wires, for example, can be wound together.

While the wire core is moving, a molten coating composition such as a molten thermoplastic composition is injected by pressure into the supplying passage 430, flows along a direction indicated by the arrow in FIG. 3(c), and then flows into the wire coating passage 432 with certain speed to coat onto the outer surface of the wire core. Subsequently, the coated wire core moves through the molding passage 436, and thus is ready for the possible subsequent manufacture process of the coated wire.

The die can be used to extrusion coating a thermoplastic composition, including but not limiting to a thermoplastic composition comprising a poly(arylene ether), a polyolefin and an impact modifier to form a coated wire. By the use of the die of present invention, wrinkles generally occurring on the coated wire can be significantly reduced or substantially eliminated when the coated wire is bent.

The die can not only be applied to coat a single-wire core and multi-wire core, but also simultaneously coat multiple wire cores in parallel or a Ribbon cable (flat cable) by providing a plurality of dies 400 in parallel.

The die may comprise more than one inner die and more than one outer die.

In one embodiment, when a plurality of above die 400 are arranged in parallel, the wire coating passage of the combined dies or the exit passage of the outer die will be a flat passage which is constructed by the parallel arrangement of said multiple individual passages, and the height of the flat passage can be referred to its inner width (Y).

When the extrusion die of the present invention is applied to construct an extrusion equipment, the extrusion equipment can be obtained by replacing the conventional extrusion die with the extrusion die and modifying the corresponding size and connection relationship accordingly. METHODS

An extrusion equipment can be used to coat a covering comprising a thermoplastic composition onto a wire core to obtain a coated wire.

A method of reducing wrinkles on covering of a coated wire comprising (a) melting a thermoplastic composition to form a melt thermoplastic composition comprising by weight of the composition: (i) 10% to 50% of a poly(arylene ether); (ii) 5% to 25% of a polyolefin; and (iii) 15% to 45% of an impact modifier; (b) optionally filtering the melt thermoplastic composition to form a filtered composition; (c) coating the filtered composition onto a wire core through the die of present invention.

In one embodiment, a method of reducing wrinkles of a coated wire, comprises steps of melting a thermoplastic composition to form a melt composition; optionally filtering the melt thermoplastic composition to form a filtered composition; allowing the filtered composition to flow into a supplying passage 430; coating the filtered composition onto a wire core in the wire coating passage 432 as the wire core is drawn from wire core passing space 442 to the exit passage 416 of the die of present invention to obtain a coated wire and molding the coated wire in the molding passage 436 of a length (A).

In one embodiment, a method of reducing wrinkles of a coated wire comprising steps of

(a) melting a thermoplastic composition to form a melt thermoplastic composition which comprises by weight of the total composition: (i) 10% to 50% of a poly(arylene ether); (ii) 5% to 25% of a polyolefin; and (iii) 15% to 45% of an impact modifier;

(b) coating the filtered composition onto a wire core using the die of present invention.

In some embodiments it may be useful to dry the thermoplastic composition before extrusion coating. Exemplary drying conditions are 60-90° C. for 2-20 hours. Additionally, in one embodiment, during extrusion coating, the thermoplastic composition is melt filtered, prior to formation of the coating.

Suitable melt filtration systems include filters made from a variety of materials such as, but not limited to, sintered-metal, metal mesh or screen, fiber metal felt, ceramic, or a combination of the foregoing materials, and the like. Particularly useful filters are sintered metal filters exhibiting high tortuosity, including the sintered wire mesh filters prepared by Pall Corporation and Martin Kurz & Company, Inc.

In one embodiment the melt filtered mixture produced by melt mixing is not pelletized. Rather the molten melt filtered mixture is formed directly into a coating for the conductor using a coating extruder that is in tandem with the melt mixing apparatus, typically a compounding extruder. The coating extruder may comprise one or more filters as described above.

The processing temperature during extrusion coating is generally less than or equal to 300° C., or, more specifically less than or equal to 280° C., or most specifically, less than or equal to 250° C. Within the scope, the processing temperature is adjusted to provide a sufficiently fluid molten composition to afford a covering for the wire core, for example, higher than the melting point of the thermoplastic composition, or more specifically at least 10° C. higher than the melting point of the thermoplastic composition.

In one embodiment, a method of extruding a covering on a wire core comprises the steps of melting a thermoplastic composition to form a melt thermoplastic composition; optionally filtering the melt thermoplastic composition to form a filtered composition; coating the filtered composition onto a wire core in an extrusion equipment comprising a die to obtain a coated wire; and molding the coated wire for an length.

Extrusion coating may employ any conventional extrusion equipment with the die of the invention.

In one embodiment, a method of coating a wire core comprises steps of (a) melting a thermoplastic composition to form a melt thermoplastic composition; (b) optionally filtering the melt thermoplastic composition to form a filtered composition; (c) coating the filtered composition onto a wire core by an extrusion die comprising an inner die 440 and an outer die 410, wherein the inner die 440 comprises a wire core passing space 442 and a projection end 446 having a length (C); wherein the outer die 410 comprises an inner space 412 and an exit passage 416; and wherein the projection end 446 of the inner die 440 is positioned at least partially within the inner space 412 and exit passage 416 of the outer die 410 to form a wire coating passage 432 and a molding passage 436.

In one embodiment, a method of coating a wire core by an extrusion die comprising an inner die 440 and an outer die 410, wherein the inner die 440 comprises a wire core passing space 442 and a projection end 446 having a length (C); wherein the outer die 410 comprises an inner space 412 and an exit passage 416; and wherein the projection end 446 of the inner die 440 is positioned at least partially within the inner space 412 and exit passage 416 of the outer die 410 to form a wire coating passage 432 and a molding passage 436, comprises the steps of (a) melting a thermoplastic composition to form a melt thermoplastic composition; (b) optionally filtering the melt thermoplastic composition to form a filtered composition; (c) coating the filtered composition onto a wire core in the wire coating passage 432; and (d) molding the coated wire in the molding passage 436.

After extrusion coating, the wire is usually cooled using a water bath, water spray, air jets, or a combination comprising one or more of the foregoing cooling methods after extrusion coating. Exemplary water bath temperatures are 5 to 60° C., in some embodiment 5° C. to 50° C., or, in some embodiments 10° C. to 40° C. After cooling the coated wire is wound onto a spool or like device, typically at a speed of 10 meters per minute (m/min) to 500 m/min.

The method can be used to reduce wrinkles of the coated wire.

In one embodiment, a method of reducing wrinkles in the coated wire comprises melting a thermoplastic composition to form a melt thermoplastic composition; optionally filtering the melt thermoplastic composition to form a filtered composition; allowing the filtered composition to flow through a supplying passage around the wire core and inward toward the wire core in a substantially uniformly manner from all direction; coating the filtered composition onto a wire core and molding the coated wire by the die of the invention.

In one embodiment, a method of reducing wrinkles in the coated wire comprises melting a thermoplastic composition to form a melt thermoplastic composition; optionally filtering the melt thermoplastic composition to form a filtered composition; coating the filtered composition onto a wire core and molding the coated wire by the die wherein the die comprises an inner die 440 and an outer die 410, wherein the inner die 440 comprises a wire core passing space 442 and a projection end 446 having a length (C); wherein the outer die 410 comprises an inner space 412 and an exit passage 416; and wherein the projection end 446 of the inner die 440 is positioned at least partially within the inner space 412 and exit passage 416 of the outer die 410 to form a wire coating passage 432 and a molding passage 436.

A coated wire can be obtained by extruding a covering onto a wire core.

### Coated Wire

A coated wire comprises a wire core and a covering disposed over the wire core. The covering comprises a thermoplastic composition comprising (i) a poly(arylene ether); (ii) a polyolefin; and (iii) an impact modifier. Preferably the thermoplastic composition comprises by weight of the composition (i) 10% to 50% of a poly(arylene ether); (ii) 5% to 25% of a polyolefin; and (iii) 15% to 45% of an impact modifier.

In one embodiment, a coated wire comprises a wire core and a covering comprising a thermoplastic composition which comprises by weight of the composition (i) 10% to 50% of a poly(arylene ether); (ii) 5% to 25% of a polyolefin; and (iii) 15% to 45% of an impact modifier; wherein the coated wire is manufactured by a die comprising an inner die 440 and an outer die 410, wherein the inner die 440 comprises a wire core passing space 442 and a projection end 446 having a length (C); wherein the outer die 410 comprises an inner space 412 and an exit passage 416; wherein the projection end 446 of the inner die 440 is positioned at least partially within the inner space 412 and exit passage 416 of the outer die 410 to form a wire coating passage 432 and a molding passage 436.

Generally, wrinkles are present on the covering coated by a thermoplastic composition comprising a poly(arylene ether) when the coated wire is bent. The typical dimension of wrinkles, irrespective of Type I wrinkles or Type II wrinkles, varies depending on size of the coated wire, the coating composition, the extrusion die, the methods of manufacturing the coated wire.

In one embodiment, Type I wrinkles have a ratio of depth to outer width (Y) of a coated wire is larger than 0.25, but less than 1, more preferably less than 0.5 and most preferably less than 0.35.

In one embodiment, Type II wrinkles have a ratio of depth to outer width (Y) of a coated wire is 0.01 to 0.25, preferably 0.05 to 0.20, more preferably 0.08 to 0.15.

In one embodiment, the coated wire has a cylindrical shape and the outer width (Y) of a coated wire is the outer diameter (Y) of a coated wire.

In one embodiment, for a 3.175 mm outer diameter wire (⅛″), the Type I wrinkles may have depth larger than 800 microns and the Type II wrinkles may have a depth of 30 to 800 microns.

In one embodiment, the Type I wrinkles generally are less than 2 mm in depth, preferably less than 1.8 mm in depth, more preferably less than 1.5 mm, and most preferably less than 1 mm. In one embodiment, for a 5 mm outer diameter wire, Type I wrinkles generally are 0.5 to 5 mm wide, preferably 1 to 3 mm wide, more preferably 1.5 to 2.5 mm wide, most preferably 1.8 to 2.2 mm wide.

In one embodiment, the dimension of type II wrinkles is less than 800 microns in depth, preferably less than 500 microns, more preferably less than 250 microns, even more preferably less than 200 microns, even more preferably less than 150 microns, still more preferably less than 100 microns, most preferably less than 50 microns. In one embodiment, Type II wrinkles are 40 to 400 microns wide, preferably 80 to 360 microns wide, more preferably 120 to 320 microns wide, most preferably 180 to 280 microns wide.

In one embodiment, a coated wire comprises a wire core and a covering comprising a thermoplastic composition comprising a poly(arylene ether), a polyolefin, and an impact modifier; wherein wrinkles on the covering of the coated wire are less than 2 mm for Type-I wrinkles in depth when the coated wire is bent.

In another embodiment, a coated wire comprises a wire core; and a covering comprising a thermoplastic composition which comprises, by weight of total composition, (i) 10% to 50% of a poly(arylene ether); (ii) 5%-25% of a polyolefin; and (iii) 15% to 45% of an impact modifier; wherein wrinkles on the covering of the coated wire are less than 200 microns for Type-II wrinkles in depth from lowest point of the surface of the coated wire when the coated wire is bent.

In one embodiment, a coated wire comprises a wire core; and a covering comprising a thermoplastic composition which comprises by weight of the composition (i) 10% to 50% of a poly(arylene ether); (ii) 5% to 25% of a polyolefin; and (iii) 15% to 45% of an impact modifier; wherein the coated wire is free of Type I wrinkle when the coated wire is bent.

In one embodiment, a coated wire comprises a wire core; and a covering comprising a thermoplastic composition which comprises by weight of the composition (i) 10% to 50% of a poly(arylene ether); (ii) 5% to 25% of a polyolefin; and (iii) 15% to 45% of an impact modifier; wherein the coated wire is free of Type II wrinkle when the coated wire is bent.

In one embodiment, a coated wire comprises a wire core; and a covering comprising a thermoplastic composition which comprises by weight of the composition (i) 10% to 50% of a poly(arylene ether); (ii) 5% to 25% of a polyolefin; and (iii) 15% to 45% of an impact modifier; wherein the coated wire is free of Type I and Type II wrinkle when the coated wire is bent.

In some embodiments, a coated wire has an outer width of less than 4 cm, preferably less than 3 cm, more preferably less than 1 cm. Within the range, the coated wire has an outer width of greater than 2 mm, preferably greater than 2.5 mm, more preferably greater than 3 mm, and most preferably greater than 3.5 mm.

The wrinkles can be tested by a method comprising the steps of setting a bending length by randomly selecting two points as point 1 to point 2 on the covering of a coated wire; bending the coated wire to bring the point 1 and point 2 being contact; determining a bending angle α between [AB] and [AC] wherein point A is located at the top of the bent samples while the distance between points B and C defines the maximum width of the bent samples; and (4) measuring wrinkles in depth from lowest point of surface of the coated wire to the top of the surface of the coated wire at the bending angle.

The term “a bending length” is defined as a distance from point 1 and point 2 wherein the point 1 and point 2 is set depending on outer width of a coated wire sample. The bending length may vary depending on the covering thickness and outer width of the coated wire to be measured. Generally, it also related to the end use of the coated wire. Generally, a ratio of the bending length to outer width of a coated wire at a range of from 5 to 20, preferably 5 to 15, more preferably 6 to 12, most preferably 7 to 10.

In one embodiment, for a coated wire having a cylindrical shape, a ratio of a bending length to diameter of the coated wire is in the range of 15:1 to 5:1, preferably 10:1 to 6:1, more preferably 8:1 to 7:1.

The term “a bending angle” is defined as an angle α formed between [AB] and [AC] when points 1 and 2 on a wire are brought together, wherein point A is located at the top of the bent sample while the distance between points B and C defines the maximum width of the bent sample. Generally, the bending angle ranges from 50 to 120 degree, preferably 50 to 100 degree, more preferably 60 to 90 degree, most preferably 70 to 80 degree.

Generally, a ratio of a bending length to outer width of the coated wire is in the range of 15:1 to 5:1, preferably 12:1 to 6:1, more preferably 9:1 to 7:1. The ratio may vary depending on outer width of the wire core.

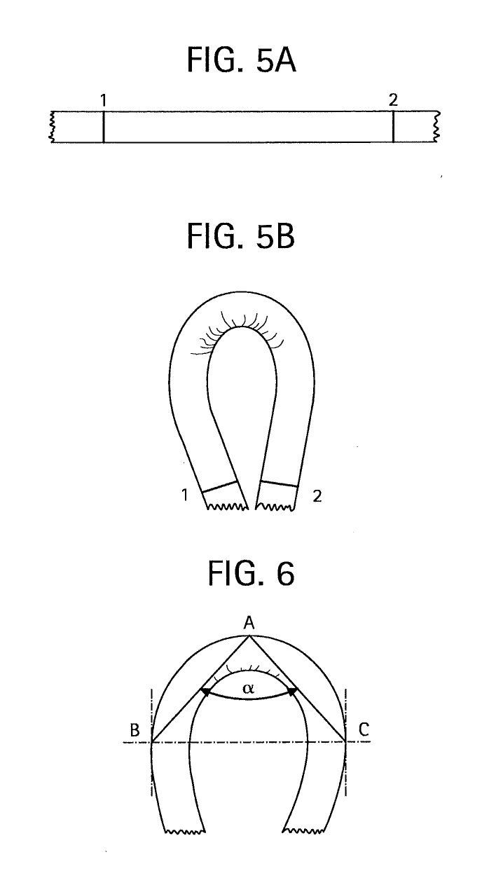

With reference to FIGS. 5 to 6, a method of testing wrinkles is illustrated: (1) selecting point 1 to point 2 to obtain a bending length (see FIG. 5(a); (2) bringing the point 1 and point 2 being contact (see FIG. 5(b)); (3) determine a bending angle α between [AB] and [AC] wherein point A is located at the top of the bent samples while the distance between points B and C defines the maximum width of the bent samples (see snapshot of the bent wire acquired by an optical microscope, see FIG. 6); and (4) measuring wrinkle(s). This procedure allows very fine wrinkles to be observed.

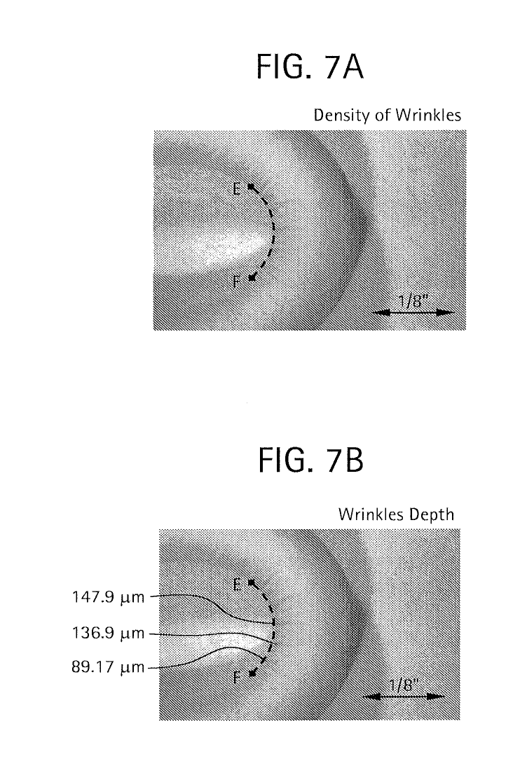

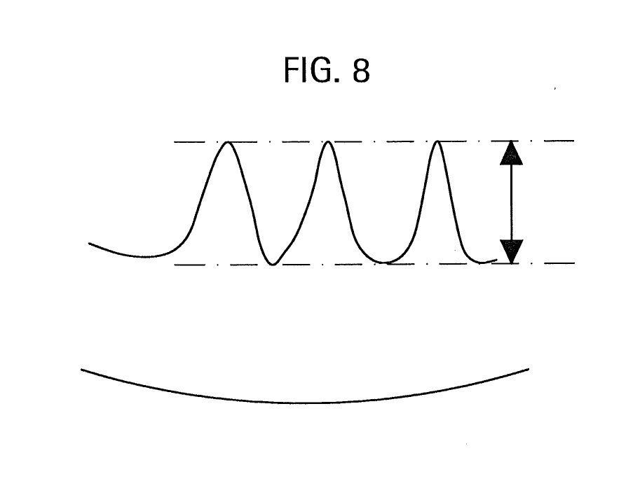

An optical micrograph is acquired for each material investigated using an Olympus SZX12 microscope, in reflected mode and bright field, at a magnification of 7× to 10×. Image analysis is performed using the Clemex Vision Pro Version 4.0 software. Two characteristics of the materials are measured: the density of wrinkles and the maximum wrinkle depth. Both are measured on the same optical micrograph. Two points E and F are defined on the bent wire image (see FIG. 7). The distance between E and F is fixed and is the same for all the micrographs. The Micro routine of the attached image analysis software counts the number of wrinkles on the wire between E and F. This defines the density of wrinkles. Then for each wrinkle between E and F the software measures the depth of each wrinkle (the depth is defined as the distance from the base of the surface of the wire to the top of the wrinkle). The maximum wrinkle depth is recorded.

In some embodiments, an extruded thermoplastic composition strand samples can be used to measure wrinkle. In one embodiment, for a thermoplastic composition extruded strand sample of 5 mm outer width, Type II wrinkles can be better characterized with a fixed length of 35 mm (distance between point 1 and point 2, see FIG. 5(a)). The curvature of bending with this measuring length has a sharp angle of approximately 70 degrees as defined by the angle α between [AB] and [AC] (see FIG. 5 (c)).

The average distance between two neighboring protruding ridge of Type II wrinkles is 50 to 450 microns, preferably 75 to 400 microns, more preferably 100 to 350 microns, most preferably 150 to 300 microns. The average distance between two neighboring protruding ridge of type I wrinkles is great than 0.5 mm, preferably 0.5-10 mm, more preferably 1-5, most preferably 2-4 mm.

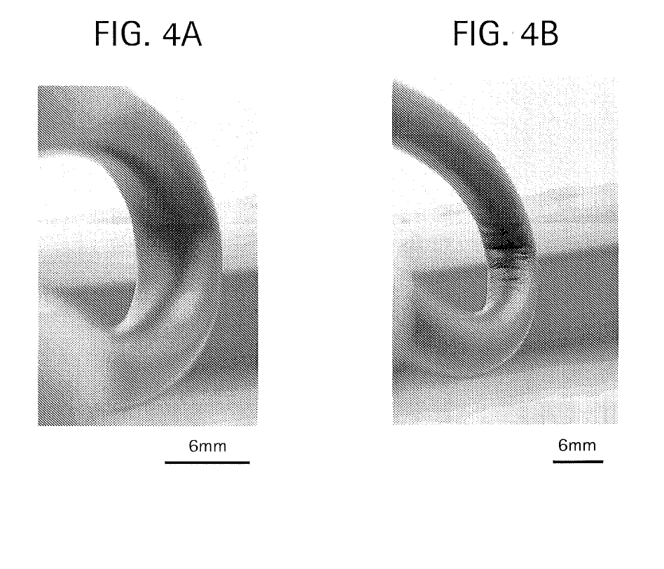

FIGS. 4(a) and 4(b) are photographs showing wrinkles on the covering of coated wires after the coated wire is bent, wherein the coated wires are extrusion coated by the extrusion die of the present invention and the conventional die shown in FIGS. 2 and 3, respectively.

As shown in FIG. 4(a), the coated wire manufactured by the die of the present invention presents few wrinkles when the wire is bent, and particularly there is no wrinkle in relatively large size. In contrast, as shown in FIG. 4(b), the wire manufactured by the conventional die shows many wrinkles when the wire is bent, and there exists wrinkles in relatively large size. The wrinkles in relatively large size formed during bending are generally considered to have adverse effect on the mechanical and physical properties of the wire.

The wire core may comprise a single strand or a plurality of strands as wires. Suitable wires include metal wire and other conductive materials. These comprise, but are not limited to, copper wire, aluminum wire, lead wire, wires of alloys comprising one or more of the foregoing metals, glass fiber, polyethylene fiber and combinations thereof. As defined herein, the wire core may be a single wire or a plurality of wires with or without one or more coverings.

In some embodiments, a plurality of wire cores may be bundled, twisted, or braided, similar to yarn or rope. Additionally, the wire core may have various shapes such as round or oblong. The wire core may be coated e.g., with tin or silver. In some embodiments, the wire core may comprise one or more conductive wires, one or more metal foils, one or more conductive inks, or a combination thereof.

In one embodiment a wire core has one or more intervening layers between the wire core and the covering to form a covering disposed over the wire core. For instance, an optional adhesion promoting layer may be included between the wire core and covering. In another embodiment the wire core may include a covering of a metal deactivator prior to coating. In another embodiment the intervening layer comprises a thermoplastic or thermoset composition that, in some cases, is foamed.

There is no particular limitation on the size of the wire core. The cross-sectional area of the wire core and thickness of the covering may vary and is typically determined by the end use of the coated wire and multi-wire core cable assembly. Generally, the covering has a thickness of 0.15 millimeters to 1.5 millimeters. Within this range the covering thickness may be greater than or equal to 0.20 millimeter, or, more specifically, greater than or equal to 0.3 millimeter. Also within this range the covering thickness may be less than or equal to 1.5 millimeters, or, more specifically, less than or equal to 1.05 millimeters. The coated wire can be used as coated wire without limitation, including, for example, wire for household electrical appliances, wire for electric power, wire for instruments, wire for data communication, wire for electric cars, as well as ships, and the like.

The coated wire comprises a covering comprising a poly(arylene ether), a polyolefin and an impact modifier.

As used herein, a “poly(arylene ether)” comprises a plurality of structural units of the formula (I):

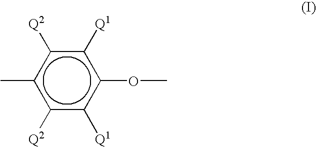

wherein for each structural unit, each Q¹ and Q² is independently hydrogen, primary or secondary lower alkyl (e.g., an alkyl containing 1 to 7 carbon atoms), phenyl, haloalkyl, aminoalkyl, alkenylalkyl, alkynylalkyl, hydrocarbonoxy, and aryl. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are tetramethyl diphenylquinone (TMDQ) end groups, typically obtained from reaction mixtures in which tetramethyl diphenylquinone by-product is present.

The poly(arylene ether) can be in the form of a homopolymer; a copolymer; a graft copolymer; an ionomer; or a block copolymer; as well as combinations comprising at least one of the foregoing. The preferred homopolymers are those containing 2,6-dimethylphenylene ether units. Suitable copolymers include random copolymers containing, for example, such units in combination with 2,3,6-trimethyl-1,4-phenylene ether units or copolymers derived from copolymerization of 2,6-dimethylphenol with 2,3,6-trimethylphenol. Also included are poly(arylene ether) containing moieties prepared by grafting vinyl monomers or polymers such as polystyrenes, as well as coupled poly(arylene ether) in which coupling agents such as low molecular weight polycarbonates, quinones, heterocycles and formulas undergo reaction in known manner with the hydroxy groups of two poly(arylene ether) chains to produce a higher molecular weight polymer. Poly(arylene ether)s further include combinations comprising at least one of the above.

The poly(arylene ether) can be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

In one embodiment, the poly(arylene ether) comprises a capped poly(arylene ether). The capping can be used to reduce the oxidation of terminal hydroxy groups on the poly(arylene ether) chain. The terminal hydroxy groups can be inactivated by capping with an inactivating capping agent via an acylation reaction, for example. The capping agent chosen is desirably one that results in a less reactive poly(arylene ether) thereby reducing or preventing crosslinking of the polymer chains and the formation of gels or black specks during processing at elevated temperatures. Suitable capping agents include, for example, esters of salicylic acid, anthranilic acid, or a substituted derivative thereof, and the like; esters of salicylic acid, and especially salicylic carbonate and linear polysalicylates, are preferred. As used herein, the term “ester of salicylic acid” includes compounds in which the carboxy group, the hydroxy group, or both have been esterified. Suitable salicylates include, for example, aryl salicylates such as phenyl salicylate, acetylsalicylic acid, salicylic carbonate, and polysalicylates, including both linear polysalicylates and cyclic compounds such as disalicylide and trisalicylide. The preferred capping agents are salicylic carbonate and the polysalicylates, especially linear polysalicylates. When capped, the poly(arylene ether) can be capped to any desirable extent up to 80 percent, more specifically up to 90 percent, and even more specifically up to 100 percent of the hydroxy groups are capped. Suitable capped poly(arylene ether) and their preparation are described in United States Pat. Nos. 4,760,118 to White et al. and 6,306,978 to Braat et al.

Capping poly(arylene ether) with polysalicylate is also believed to reduce the amount of aminoalkyl terminated groups present in the poly(arylene ether) chain. The aminoalkyl groups are the result of oxidative coupling reactions that employ amines in the process to produce the poly(arylene ether). The aminoalkyl group, ortho to the terminal hydroxy group of the poly(arylene ether), can be susceptible to decomposition at high temperatures. The decomposition is believed to result in the regeneration of primary or secondary amine and the production of a quinone methide end group, which may in turn generate a 2,6-dialkyl-1-hydroxyphenyl end group. Capping of poly(arylene ether) containing aminoalkyl groups with polysalicylate is believed to remove such amino groups to result in a capped terminal hydroxy group of the polymer chain and the formation of 2-hydroxy-N,N-alkylbenzamine (salicylamide). The removal of the amino group and the capping provides a poly(arylene ether) that is more stable to high temperatures, thereby resulting in fewer degradative products, such as gels or black specks, during processing of the poly(controlled distribution arylene ether).

The poly(arylene ether) can be functionalized with a polyfunctional compound such as a polycarboxylic acid or those compounds having in the molecule both (a) a carbon-carbon double bond or a carbon-carbon triple bond and b) at least one carboxylic acid, anhydride, amide, ester, imide, amino, epoxy, orthoester, or hydroxy group. Examples of such polyfunctional compounds include maleic acid, maleic anhydride, fumaric acid, and citric acid.

The poly(arylene ether) can have a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s may have an initial intrinsic viscosity greater than 0.3 deciliters per gram (dl/g), as measured in chloroform at 25° C. Initial intrinsic viscosity is defined as the intrinsic viscosity of the poly(arylene ether) prior to compounding with the other components of the composition. As understood by one of ordinary skill in the art the viscosity of the poly(arylene ether) can be up to 30% higher after compounding. The percentage of increase can be calculated by (final intrinsic viscosity—initial intrinsic viscosity)/initial intrinsic viscosity. Determining an exact ratio, when two intrinsic viscosities are used, will depend somewhat on the exact intrinsic viscosities of the poly(arylene ether) used and the ultimate physical properties that are desired.

The poly(arylene ether) may have a hydroxy end group content of less than or equal to 6300 parts per million based on the total weight of the poly(arylene ether) (ppm) as determined by Fourier Transform Infrared Spectrometry (FTIR). In one embodiment the poly(arylene ether) may have a hydroxy end group content of less than or equal to 3000 ppm, or, more specifically, less than or equal to 1500 ppm, or, even more specifically, less than or equal to 500 ppm.

The poly(arylene ether) can be substantially free of visible particulate impurities. In one embodiment, the poly(arylene ether) is substantially free of particulate impurities greater than 15 micrometers. As used herein, the term “substantially free of visible particulate impurities” means that a ten gram sample of the poly(arylene ether) dissolved in fifty milliliters of chloroform (CHCl₃) exhibits fewer than 5 visible specks when viewed in a light box. Particles visible to the naked eye are typically those greater than 40 micrometers in diameter. As used herein, the term “substantially free of particulate impurities greater than 15 micrometers” means that of a forty gram sample of poly(arylene ether) dissolved in 400 milliliters of CHCl₃, the number of particulates per gram having a size of 15 micrometers is less than 50, as measured by a Pacific Instruments ABS2 analyzer based on the average of five samples of twenty milliliter quantities of the dissolved poly(arylene ether) that is allowed to flow through the analyzer at a flow rate of one milliliter per minute (plus or minus five percent).

In one embodiment, the poly(arylene ether) can be present in the thermoplastic composition in an amount of 10 to 50 weight percent, based on the total weight of the thermoplastic composition. Within this range the poly(arylene ether) can be present in an amount greater than or equal to 12, or, more specifically, greater than or equal to 15 weight percent, or, even more specifically, greater than or equal to 18 weight percent, most specifically, greater than or equal to 20 weight percent based on the total weight of the thermoplastic composition. Also within this range the poly(arylene ether) can be present in an amount less than or equal to 45, or, more specifically, less than or equal to 40, or, even more specifically, less than or equal to 35 weight percent based on the total weight of the thermoplastic composition.

The thermoplastic composition may comprise a polyolefin. Polyolefins which can be included are of a polymer of a monomer of a hydrocarbon having one or more ethylenically unsaturated double bonds. For example, polyethylene, polybutene, polypropylene, polyisobutylene, and combinations of one or more of the foregoing, with preferred homopolymers being polybutene, polyethylene, LDPE (low density polyethylene), LLDPE (linear low density polyethylene), HDPE (high density polyethylene), MDPE (medium density polyethylene), polypropylene, and combinations of two or more of the foregoing. Polyolefin resins of this general structure and methods for their preparation are well known in the art and are described for example in U.S. Pat. Nos. 2,933,480, 3,093,621, 3,211,709, 3,646,168, 3,790,519, 3,884,993, 3,894,999, 4,059,654, 4,166,055 and 4,584,334.

Copolymers of polyolefins may also be used such as copolymers of ethylene and alpha olefins having three to twelve carbons or functionalized alpha olefins having three to twelve carbons. Exemplary alpha olefins include propylene and 4-methylpentene-1,1-butene, 2-butene, 1-pentene, 2-pentene, 1-hexene, 2-hexene and 3-hexene etc. Exemplary functionalized alpha olefins include olefins such as ethylene functionalized with vinyl acetate, ethylene functionalized with acrylate and ethylene functionalized with substituted acrylate groups. Copolymers of ethylene and C₃-C₁₀ monoolefins and non-conjugated dienes, herein referred to as EPDM copolymers, are also suitable. Examples of suitable C₃-C₁₀ monoolefins for EPDM copolymers include propylene, 1-butene, 2-butene, 1-pentene, 2-pentene, 1-hexene, 2-hexene and 3-hexene. Suitable dienes include 1,4 hexadiene and monocylic and polycyclic dienes. Mole ratios of ethylene to other C₃-C₁₀ monoolefin monomers can range from 95:5 to 5:95 with diene units being present in the amount of from 0.1 to 10 mol %. EPDM copolymers can be functionalized with an acyl group or electrophilic group for grafting onto the polyphenylene ether as disclosed in U.S. Pat. No. 5,258,455.

The polyolefin, when used, can be present in the thermoplastic composition in an amount of 5 to 25 weight percent, based on the total weight of the thermoplastic composition. Within this range the polyolefin can be present in an amount greater than or equal to 8, or, more specifically, greater than or equal to 10, or, even more specifically, greater than or equal to 15 weight percent based on the total weight of the thermoplastic composition. Also within this range the polyolefin can be present in an amount less than or equal to 22, or, more specifically, less than or equal to 20, or, even more specifically, less than or equal to 18 weight percent based on the total weight of the thermoplastic composition.

The thermoplastic composition comprises an impact modifier.

Particularly suitable thermoplastic impact modifiers are block copolymers. As used herein and throughout the specification “block copolymer” refers to a single block copolymer or a combination of block copolymers. The block copolymer comprises at least one block (A) comprising repeating aryl alkylene units and at least one block (B) comprising repeating alkylene units. The arrangement of blocks (A) and (B) may be a linear structure or a so-called radial teleblock structure having branched chains. A-B-A triblock copolymers have two blocks A comprising repeating aryl alkylene units.

The pendant aryl moiety of the aryl alkylene units may be monocyclic or polycyclic and may have a substituent at any available position on the cyclic portion. Suitable substituents include alkyl groups having 1 to 4 carbons. An exemplary aryl alkylene unit is phenylethylene, which is shown in Formula II:

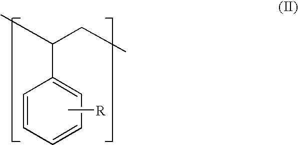

wherein R represents H and C₁₋₄ alkyl substituted at substitutable position of the benzene ring.

Particularly suitable block copolymers comprise, for example, A-B diblock copolymers and A-B-A triblock copolymers having of one or two alkenyl aromatic blocks A, which are typically styrene blocks or blocks of a copolymer of styrene and one or more 1,3-cyclodienes such as 1,3-cyclohexadiene, and a rubber block, B, which can be a polymer or copolymer block resulting from the polymerization of a conjugated diene such as butadiene, a 1,3-cyclodiene such as 1,3-cyclohexadiene or a combination of conjugated dienes or a copolymer block resulting from the copolymerization of a conjugated diene and an alkenyl aromatic compound. The copolymer block itself can be a block copolymer. The repeating units resulting from the polymerization of the conjugated dienes can be partially or completely hydrogenated. After a repeating unit resulting from the polymerization of a conjugated diene has been hydrogenated the repeating unit may be described as an alkene unit. Each occurrence of alkenyl aromatic block A may have a molecular weight which is the same or different than other occurrences of alkenyl aromatic block A. Similarly each occurrence of rubber block B may have a molecular weight which is the same or different than other occurrences rubber block B.

Block A may further comprise alkylene units having 2 to 15 carbons as long as the quantity of aryl alkylene units exceeds the quantity of alkylene units.

Block B comprises repeating alkylene units having 2 to 15 carbons such as ethylene, propylene, butylene or combinations of two or more of the foregoing. Block B may further comprise aryl alkylene units as long as the quantity of alkylene units exceeds the quantity of aryl alkylene units.

Each occurrence of block A may have a molecular weight which is the same or different than other occurrences of block A. Similarly each occurrence of block B may have a molecular weight which is the same or different than other occurrences of block B. The block copolymer may be functionalized by reaction with an alpha-beta unsaturated carboxylic acid. In one embodiment, the B block comprises a copolymer of aryl alkylene units and alkylene units having 2 to 15 carbons such as ethylene, propylene, butylene or combinations of two or more of the foregoing. The B block may further comprise some unsaturated non-aromatic carbon-carbon bonds.

Exemplary A-B and A-B-A copolymers include, but are not limited to, polystyrene-polybutadiene, polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene-poly(ethylene-butylene)-polystyrene, polystyrene-(ethylene-butylene/styrene copolymer)-polystyrene, polystyrene-polyisoprene-polystyrene, and poly(alpha-methylstyrene)-polybutadiene-poly(alpha-methylstyrene), as well as the selectively hydrogenated versions thereof, and the like. Mixtures of the aforementioned block copolymers are also useful. Such A-B and A-B-A block copolymers are available commercially from a number of sources, including Phillips Petroleum under the trademark SOLPRENE, Kraton Polymers Ltd. under the trademark KRATON, Dexco under the trademark VECTOR, and Kuraray under the trademark SEPTON.

In one embodiment the impact modifier comprises impact modifiers having varying amounts of alkenyl aromatic units. For example a combination of a polystyrene-poly(ethylene-butylene)-polystyrene having a polystyrene content of 10 weight percent to 20 weight percent, based on the total weight of the block copolymer and a polystyrene-poly(ethylene-butylene)-polystyrene having a polystyrene content of 25 weight percent to 50 weight percent, based on the total weight of the block copolymer.

In one embodiment the impact modifier comprises a block copolymer having (A) one or more blocks comprising repeating alkenyl aromatic units and (C) one or more blocks that is a controlled distribution copolymer block. Block A may further comprise alkene units having 2 to 15 carbons as long as the quantity of alkenyl aromatic units exceeds the quantity of alkene units.

In one embodiment the block copolymer comprises an alkenyl aromatic/alkene controlled distribution copolymer block, wherein the proportion of alkenyl aromatic units increases gradually to a maximum near the middle or center of the block and then decreases gradually until the opposite end of the polymer block is reached.

In one embodiment the first 15 to 25% and the last 15 to 85% of the alkenyl aromatic/alkene controlled distribution copolymer block are alkene rich, with the remainder considered to be alkenyl aromatic rich. The term “alkene rich” means that the region has a measurably higher ratio of alkene to alkenyl aromatic than the center region. For the controlled distribution copolymer block the weight percent of alkenyl aromatic in each controlled distribution copolymer block can be 10 weight percent to 75 weight percent, or more specifically 25 weight percent to 50 weight percent, based on the total weight of the controlled distribution copolymer block.

Anionic, solution copolymerization to form the controlled distribution copolymers can be carried out using known methods and materials. In general, the copolymerization is attained anionically, using known selections of adjunct materials, including polymerization initiators, solvents, promoters, and structure modifiers, but as a key feature, in the presence of a distribution agent. An exemplary distribution agent is a non-chelating ether. Examples of such ether compounds are cyclic ethers such as tetrahydrofuran and tetrahydropyrane and aliphatic monoethers such as diethyl ether and dibutyl ether. Production of block copolymers comprising a controlled distribution copolymer block is taught in United States Patent Application No. 2003/0176582.

One feature of the impact modifier comprising an alkenyl aromatic block and a controlled distribution copolymer block is that it can have two or more Tg's, the lower being the single Tg of the controlled distribution copolymer block. The controlled distribution copolymer block Tg is typically greater than or equal to −60° C., or, more specifically, greater than or equal to −40° C. The controlled distribution copolymer block Tg is typically less than or equal to +30° C., or, even more specifically, less than or equal to +10° C. The second Tg, that of the alkenyl aromatic block, is +80° C. to +110° C., or, more specifically, +80° C. to +105° C.

Each A block may have an average molecular weight of 3,000 to 60,000 g/mol and each C block may have an average molecular weight of 30,000 to 300,000 g/mol as determined by gel permeation chromatography using polystyrene standards. The total amount of alkenyl aromatic units is 15 to 75 weight percent, based on the total weight of the block copolymer. The B block may be a controlled distribution copolymer. As used herein “controlled distribution” is defined as referring to a molecular structure lacking well-defined blocks of either monomer, with “runs” of any given single monomer attaining a maximum number average of 20 to 50 units as shown by either the presence of only a single glass transition temperature (Tg), intermediate between the Tg of either homopolymer, or as shown via proton nuclear magnetic resonance methods. When the B block comprises a controlled distribution copolymer, each A block may have an average molecular weight of 3,000 to 60,000 g/mol and each B block may have an average molecular weight of 30,000 to 300,000 g/mol. When the B block is a controlled distribution polymer, each B block comprises at least one terminal region adjacent to an A block that is rich in alkylene units and a region not adjacent to the A block that is rich in aryl alkylene units. The total amount of aryl alkylene units is 15 to 75 weight percent, based on the total weight of the block copolymer. The weight ratio of alkylene units to aryl alkylene units in the B block may be 5:1 to 1:2. Exemplary block copolymers are further disclosed in U.S. Patent Applications Nos. 2003/181584, 2003/0176582, and 2004/0138371 and are commercially available from Kraton Polymers under the trademark KRATON. Exemplary grades are A-RP6936 and A-RP6935.

In one embodiment, the impact modifier comprises two block copolymers. The first block copolymer has an aryl alkylene content greater than to equal to 50 weight percent based on the total weight of the first block copolymer. The second block copolymer has an aryl alkylene content less than or equal to 50 weight percent based on the total weight of the second block copolymer. An exemplary combination of block copolymers is a first polyphenylethylene-poly(ethylene/butylene)-polyphenylethylene having a phenylethylene content of 15 weight percent to 40 weight percent, based on the total weight of the block copolymer and a second polyphenylethylene-poly(ethylene-butylene)-polyphenylethylene having a phenylethylene content of 55 weight percent to 70 weight percent, based on the total weight of the block copolymer may be used. Exemplary block copolymers having an aryl alkylene content greater than 50 weight percent are commercially available from Asahi under the trademark TUFTEC and have grade names such as H1043, as well as some grades available under the tradename SEPTON from Kuraray. Exemplary block copolymers having an aryl alkylene content less than 50 weight percent are commercially available from Kraton Polymers under the trademark KRATON and have grade names such as G-1701, G-1702, G-1730, G-1641, G-1650, G-1651, G-1652, G-1657, A-RP6936 and A-RP6935.

In one embodiment, the impact modifier comprises a combination of a controlled distribution block copolymer and an alkenyl aromatic block copolymer. Exemplary controlled distribution block copolymers are commercially available from Kraton Polymers under the trademark KRATON and have grade names such as A-RP6936 and A-RP6935. Exemplary alkenyl aromatic block copolymers are commercially available from Kraton Polymers under the trademark KRATON and have grade names such as G-1701, G-1702, G-1730, G-1641, G-1650, G-1651, G-1652 and G-1657.

In one embodiment, the impact modifier comprises impact modifiers having varying amounts of alkenyl aromatic units. For example a combination of a polystyrene-poly(ethylene-butylene)-polystyrene having a polystyrene content of 10 weight percent to 20 weight percent, based on the total weight of the block copolymer and a polystyrene-poly(ethylene-butylene)-polystyrene having a polystyrene content of 25 weight percent to 50 weight percent, based on the total weight of the block copolymer.

In one embodiment, the impact modifier can be functionalized in a number of ways. One way is by treatment with an unsaturated monomer having one or more functional groups or their derivatives, such as carboxylic acid groups and their salts, anhydrides, esters, imide groups, amide groups, and acid chlorides. Exemplary monomers include maleic anhydride, maleic acid, fumaric acid, and their derivatives. A further description of functionalizing such block copolymers can be found in U.S. Pat. No. 4,578,429 and in U.S. Pat. No. 5,506,299. In another manner, the impact modifier can be functionalized by grafting silicon or boron containing compounds to the polymer as taught in U.S. Pat. No. 4,882,384. In still another manner, the impact modifier can be contacted with an alkoxy-silane compound to form a silane-modified block copolymer. In yet another manner, the impact modifier can be functionalized by grafting at least one ethylene oxide molecule to the polymer as taught in U.S. Pat. No. 4,898,914, or by reacting the polymer with carbon dioxide as taught in U.S. Pat. No. 4,970,265. Still further, the impact modifier can be metallated as taught in U.S. Pat. Nos. 5,206,300 and 5,276,101, wherein the polymer is contacted with an alkali metal alkyl, such as a lithium alkyl. And still further, the impact modifier can be functionalized by grafting sulfonic groups to the polymer as taught in U.S. Pat. No. 5,516,831.

In some embodiments the impact modifier is present in an amount sufficient to attain a combination of softness (as described above by Shore A and Shore D) and flexural modulus (as described above). The impact modifier can be present in the thermoplastic composition in an amount of 15 to 45 weight percent, based on the total weight of the thermoplastic composition. Within this range the impact modifier can be present in an amount greater than or equal to 18, or, more specifically, greater than or equal to 20, or, even more specifically, greater than or equal to 25 weight percent based on the total weight of the thermoplastic composition. Also within this range the impact modifier can be present in an amount less than or equal to 42, or, more specifically, less than or equal to 40 or, even more specifically, less than or equal to 35 weight percent based on the total weight of the thermoplastic composition.

In one embodiment, a thermoplastic composition comprises by weight of the total composition (i) 10% to 50% of a poly(arylene ether); (ii) 5% to 25% of a polyolefin; and (iii) 15% to 45% of an impact modifier.

The thermoplastic composition may optionally comprise a flame retardant additive composition comprising a phosphoric acid salt, a metal hydroxide and an organic phosphate.

The flame retardant additive composition comprises a phosphoric acid salt selected from the group consisting of melamine phosphate, melamine pyrophosphate, melamine orthophosphate, ammonium phosphate, phosphoric acid amide, melamine polyphosphate, ammonium polyphosphate, polyphosphoric acid amide and combinations of two or more of the foregoing; a metal hydroxide; and an organic phosphate. The flame retardant additive composition has the advantage of providing excellent flame retardance at lower levels of organic phosphate than organic phosphate alone, thus decreasing or eliminating plate-out and migration in thermoplastic compositions. The flame retardant additive composition can be used with a wide range of thermoplastics and combinations of thermoplastics to decrease the flammability of the thermoplastic and to yield flame retardant thermoplastic compositions.

In one embodiment the flame retardant additive composition consists essentially of a phosphoric acid salt selected from the group consisting of melamine phosphate, melamine pyrophosphate, melamine orthophosphate, ammonium phosphate, phosphoric acid amide, melamine polyphosphate, ammonium polyphosphate, polyphosphoric acid amide and combinations of two or more of the foregoing; a metal hydroxide; and an organic phosphate. “Consisting essentially of” as used herein allows the inclusion of additional components as long as those additional components do not materially affect the basic and novel characteristics of the flame retardant additive, such as the ability to provide the same or greater level of flame retardance to a thermoplastic composition at lower levels of organic phosphate than organic phosphate alone and/or being essentially free (containing less than 0.05 weight percent, or, more specifically less than 0.005 weight percent, based on the combined weight of phosphoric acid salt, metal hydroxide and organic phosphate) of chlorine and bromine.

In another embodiment the flame retardant additive composition consists of a phosphoric acid salt selected from the group consisting of melamine phosphate, melamine pyrophosphate, melamine orthophosphate, monoammonium phosphate, diammonium phosphate, phosphoric acid amide, melamine polyphosphate, ammonium polyphosphate, polyphosphoric acid amide, and combinations of two or more of the foregoing; a metal hydroxide; and an organic phosphate.

As mentioned above, the phosphoric acid salt can be selected from the group consisting of melamine phosphate (for example, CAS No. 20208-95-1), melamine pyrophosphate (for example, CAS No. 15541-60-3), melamine orthophosphate (for example, CAS No. 20208-95-1), monoammonium phosphate (for example, CAS No. 7722-76-1), diammonium phosphate (for example, CAS No. 7783-28-0), phosphoric acid amide (for example, CAS No. 680-31-9), melamine polyphosphate (for example, CAS No. 20208-95-1), ammonium polyphosphate (for example, CAS No. 68333-79-9), polyphosphoric acid amide and combinations of two or more of the foregoing phosphoric acid salts. The phosphoric acid salt can be surface coated with one or more of compounds selected from melamine monomer, melamine resin, modified melamine resin, guanamine resin, epoxy resin, phenol resin, urethane resin, urea resin, silicone resin, and the like. The identity of the surface coating, when present, is typically chosen based upon the identity of the thermoplastic components of the fire retardant thermoplastic composition. In one embodiment the phosphoric acid salt comprises melamine polyphosphate.

Phosphoric acid salts are commercially available or can be synthesized by the reaction of a phosphoric acid with the corresponding amine containing compound as is taught in the art.

The phosphoric acid salt can be present in the flame retardant additive composition in an amount of 3 to 40 weight percent, based on the combined weight of phosphoric acid salt, metal hydroxide and organic phosphate. Within this range the phosphoric acid salt can be present in an amount greater than or equal to 3, or, more specifically, greater than or equal to 8, or, even more specifically, greater than or equal to 10 weight percent based on the combined weight of phosphoric acid salt, metal hydroxide and organic phosphate. Also within this range the phosphoric acid salt can be present in an amount less than or equal to 35, or, more specifically, less than or equal to 30, or, even more specifically, less than or equal to 20, or, most specifically, less than or equal to 15 weight percent based on the combined weight of phosphoric acid salt, metal hydroxide and organic phosphate.

Suitable metal hydroxides include all those capable of providing fire retardance, as well as combinations thereof. The metal hydroxide can be chosen to have substantially no decomposition during processing of the fire additive composition and/or flame retardant thermoplastic composition. Substantially no decomposition is defined herein as amounts of decomposition that do not prevent the fire retardant additive composition from providing the desired level of fire retardance. Exemplary metal hydroxides include, but are not limited to, magnesium hydroxide (for example, CAS No. 1309-42-8), aluminum hydroxide (for example, CAS No. 21645-51-2), cobalt hydroxide (for example, CAS No. 21041-93-0) and combinations of two or more of the foregoing. In one embodiment, the metal hydroxide comprises magnesium hydroxide. In some embodiments the metal hydroxide has an average particle size less than or equal to 10 micrometers and/or a purity greater than or equal to 90 weight percent. In some embodiments it is desirable for the metal hydroxide to contain substantially no water, i.e. a weight loss of less than 1 weight percent upon drying at 120° C. for 1 hour. In some embodiments the metal hydroxide can be coated, for example, with stearic acid or other fatty acid.

The metal hydroxide can be present in the flame retardant additive composition in an amount of 3 to 45 weight percent, based on the combined weight of phosphoric acid salt, metal hydroxide and organic phosphate. Within this range the metal hydroxide can be present in an amount greater than or equal to 5, or, more specifically, greater than or equal to 8, or, even more specifically, greater than or equal to 10 weight percent based on the combined weight of phosphoric acid salt, metal hydroxide and organic phosphate. Also within this range the metal hydroxide can be present in an amount less than or equal to 40, or, more specifically, less than or equal to 20, or, even more specifically, less than or equal to 15, or, most specifically, less than or equal to 12 weight percent based on the combined weight of phosphoric acid salt, metal hydroxide and organic phosphate.

In one embodiment the weight ratio of metal hydroxide to phosphoric acid salt is greater than or equal to 0.8, or, more specifically, greater than or equal to 1.0.

In another embodiment, the weight ratio of metal hydroxide to phosphoric acid salt is 0.3 to 0.8.

The organic phosphate can be an aromatic phosphate compound of the formula (IX):

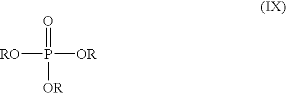

wherein each R is independently an alkyl, cycloalkyl, aryl, alkyl substituted aryl, halogen substituted aryl, aryl substituted alkyl, halogen, or a combination of any of the foregoing, provided at least one R is aryl or alkyl substituted aryl.

Examples include phenyl bisdodecyl phosphate, phenylbisneopentyl phosphate, phenyl-bis(3,5,5′-tri-methyl-hexyl phosphate), ethyldiphenyl phosphate, 2-ethyl-hexyldi(p-tolyl) phosphate, bis-(2-ethylhexyl) p-tolylphosphate, tritolyl phosphate, bis-(2-ethylhexyl) phenyl phosphate, tri-(nonylphenyl) phosphate, di (dodecyl) p-tolyl phosphate, tricresyl phosphate, triphenyl phosphate, dibutylphenyl phosphate, 2-chloroethyldiphenyl phosphate, p-tolyl bis(2,5,5′-trimethylhexyl) phosphate, 2-ethylhexyldiphenyl phosphate, and the like. In one embodiment the phosphate is one in which each R is aryl and/or alkyl substituted aryl, such as triphenyl phosphate and tris(alkyl phenyl) phosphate.

Alternatively, the organic phosphate can be a di- or polyfunctional compound or polymer having the formula (X), (XI), or (XII) below:

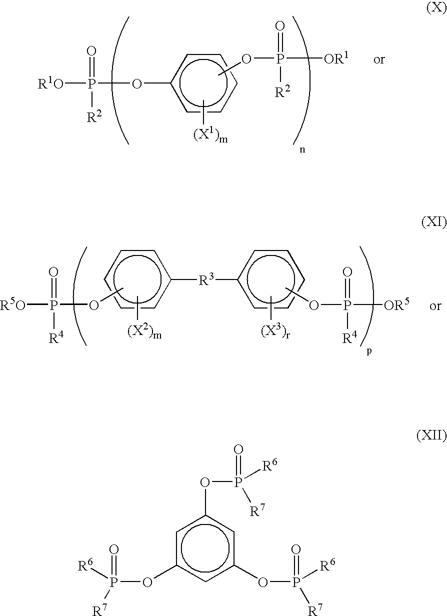

including mixtures thereof, in which R¹, R³ and R⁵ are, independently, hydrocarbon; R², R⁴, R⁶ and R⁷ are, independently, hydrocarbon or hydrocarbonoxy; X¹, X² and X³ are, independently, halogen; m and r are 0 or integers from 1 to 4, and n and p are from 1 to 30.

Examples include the bis diphenyl phosphates of resorcinol, hydroquinone and bisphenol-A, respectively, or their polymeric counterparts.

Methods for the preparation of the aforementioned di- and polyfunctional aromatic phosphates are described in British Patent No. 2,043,083.

Exemplary organic phosphates include, but are not limited to, phosphates containing substituted phenyl groups, phosphates based upon resorcinol such as, for example, resorcinol bis-diphenylphosphate, as well as those based upon bis-phenols such as, for example, bis-phenol A bis-diphenylphosphate. In one embodiment, the organic phosphate is selected from tris(butyl phenyl) phosphate (for example, CAS No. 89492-23-9, and 78-33-1), resorcinol bis-diphenylphosphate (for example, CAS No. 57583-54-7), bis-phenol A bis-diphenylphosphate (for example, CAS No. 181028-79-5), triphenyl phosphate (for example, CAS No. 115-86-6), tris(isopropyl phenyl) phosphate (for example, CAS No. CAS No. 68937-41-7) and mixtures of two or more of the foregoing.

In one embodiment, the organic phosphate can be present in the flame retardant additive composition in an amount of 3 to 45 weight percent, based on the total weight of the flame retardant additive composition. Within this range the organic phosphate can be present in an amount greater than or equal to 5, or specifically greater than or equal to 8 weight percent based on the total weight of the flame retardant additive composition. Also within this range the organic phosphate can be present in an amount less than or equal to 35, or, more specifically, less than or equal to 20, or, even more specifically, less than or equal to 15, or most specifically, less than or equal to 10 weight percent based on the total weight of the flame retardant additive composition.

The flame retardant additive composition can be present in the thermoplastic composition in an amount of 10 to 40 weight percent, based on the total weight of the total composition. Within this range the flame retardant additive composition can be present in an amount greater than or equal to 12, or, more specifically, greater than or equal to 15 weight percent based on the total weight of the thermoplastic composition. Also within this range the flame retardant additive composition can be present in an amount less than or equal to 35, more specifically, less than or equal to 30, or, even more specifically, less than or equal to 25 weight percent based on the total weight of the thermoplastic composition.

The components of the flame retardant additive composition can be mixed together to form an additive composition. Alternatively, as discussed in detail below, the components can be blended with a thermoplastic to form a masterbatch or added individually, simultaneously, sequentially or a combination thereof, to the thermoplastic composition during or after its formation.

In one embodiment, a thermoplastic composition comprises (i) 10% to 50%% of a poly(arylene ether); (ii) 5% to 25% of a polyolefin; (iii) 15% to 45% of an impact modifier; and (iv) 10% to 40% of a flame retardant additive composition comprising by weight of the flame retardant additive composition: 3% to 20% of a phosphoric acid salt selected from the group consisting of melamine phosphate, melamine pyrophosphate, melamine orthophosphate, diammonium phosphate, mono-ammonium phosphate, phosphoric acid amide, melamine polyphosphate, ammonium polyphosphate, polyphosphoric acid amide, and combinations of two or more of the foregoing; 3% to 15% of a metal hydroxide; and 3% to 15% of an organic phosphate.

The thermoplastic composition may optionally comprise a poly(alkenyl aromatic) resin. The term “poly(alkenyl aromatic) resin” as used herein includes polymers prepared by methods known in the art including bulk, suspension, and emulsion polymerization, which contain at least 25% by weight of structural units derived from an alkenyl aromatic monomer of the formula

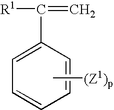

wherein R¹ is hydrogen, C₁-C₈ alkyl, or halogen; Z¹ is vinyl, halogen or C₁-C₈ alkyl; and p is 0 to 5. Preferred alkenyl aromatic monomers include styrene, chlorostyrene, and vinyltoluene. The poly(alkenyl aromatic) resins include homopolymers of an alkenyl aromatic monomer; non-elastomeric random, radial and tapered block copolymers of an alkenyl aromatic monomer, such as styrene, with one or more different monomers such as acrylonitrile, butadiene, alpha-methylstyrene, ethylvinylbenzene, divinylbenzene and maleic anhydride; and rubber-modified poly(alkenyl aromatic) resins comprising blends and/or grafts of a rubber modifier and a homopolymer of an alkenyl aromatic monomer (as described above), wherein the rubber modifier can be a polymerization product of at least one C₄-C₁₀ nonaromatic diene monomer, such as butadiene or isoprene, and wherein the rubber-modified poly(alkenyl aromatic) resin comprises 98 to 70 weight percent of the homopolymer of an alkenyl aromatic monomer and 2 to 30 weight percent of the rubber modifier. Rubber-modified polystyrenes are also known as high-impact polystyrenes or HIPS. In one embodiment the rubber-modified poly(alkenyl aromatic) resin comprises 88 to 94 weight percent of the homopolymer of an alkenyl aromatic monomer and 6 to 12 weight percent of the rubber modifier.

The composition may comprise the poly(alkenyl aromatic) resin, when present, in an amount of 1 to 46 weight percent, based on the total weight of the thermoplastic composition. Within this range the poly(alkenyl aromatic) resin can be present in an amount greater than or equal to 2, or, more specifically, greater than or equal to 4, or, even more specifically, greater than or equal to 6 weight percent based on the total weight of the thermoplastic composition. Also within this range the poly(alkenyl aromatic) resin can be present in an amount less than or equal to 25, or, more specifically, less than or equal to 20, or, even more specifically, less than or equal to 15 weight percent based on the total weight of the thermoplastic composition.

The thermoplastic composition may optionally comprise a plasticizer.

The plasticizer comprises an alkylated phosphoric acid ester compound which may be a polyphosphoric acid ester compound, a monophosphoric compound, liquid and mineral oil or a combination of the foregoing. Without being bound by theory it is believed that the presence of the alkyl groups on the alkylated phosphoric acid ester compound improves the affinity of the alkylated phosphoric acid ester compound for the olefinic phase, particularly when the alkyl groups comprise three or more carbons. The presence of the plasticizer at least partly in the olefinic phase significantly impacts the physical properties of flexible composition, particularly the Shore A hardness.

The phosphoric acid ester compound contains a specific linker derived from a bis(hydroxyaryl)alkane and alkyl-substituted phenyl moieties at the terminal.

The specific bis(hydroxyaryl)alkanes useful as linker precursors include bisphenols such as bisphenol A, 2,2-bis(4-hydroxy-3-methylphenyl)propane, bis(4-hydroxyphenyl)methane, bis(4-hydroxy-3,5-dimethylphenyl)methane and 1,1-bis(4-hydroxyphenyl)ethane. However, they are not limited to the bisphenols. Of these, bisphenol A is preferred.

As the alkyl substituted monofunctional phenol to be used to introduce the terminal alkyl-substituted phenyl moieties, a monoalkylphenol, a dialkylphenol and a trialkylphenol may be used alone or in combination.

The polyphosphoric acid ester compound can be obtained by reacting the specific bifunctional phenol and the alkyl substituted monofunctional phenol with phosphorus oxychloride. Methods for obtaining the polyphosphoric acid ester compound are not limited to this method.

In some embodiments, the plasticizer is generally used in an amount of 0 to 35 weight percent based on the total weight of the composition. Within this range the amount of plasticizer may be greater than or equal to 1, preferably greater than or equal to 3 and more preferably greater than or equal to 5 weight percent based on the total weight of the composition. Also within this range the amount of plasticizer may be less than or equal to 20, preferably less than or equal to 10, more preferably less than 8 weight percent based on the total weight of the composition.

In some embodiments, the plasticizer is generally used in an amount of less than 10%, based on the total weight of the composition. Within this range the amount of plasticizer may be greater than or equal to 3, preferably greater than or equal to 5 and more preferably greater than or equal to 8 weight percent based on the total weight of the composition.

In one embodiment, a thermoplastic composition comprises (i) 10% to 50% of a poly(arylene ether); (ii) 5% to 25% of a polyolefin; (iii) 15% to 45% of an impact modifier; (iv) 10% to 40% of a flame retardant additive composition comprising by weight of the flame retardant additive composition: 3% to 20% of a phosphoric acid salt selected from the group consisting of melamine phosphate, melamine pyrophosphate, melamine orthophosphate, diammonium phosphate, mono-ammonium phosphate, phosphoric acid amide, melamine polyphosphate, ammonium polyphosphate, polyphosphoric acid amide, and combinations of two or more of the foregoing; 3% to 15% of a metal hydroxide; and 3% to 15% of an organic phosphate; and (v) less than 10% of a plasticizer wherein the plasticizer is preferably selected from liquid polybutene, mineral oil and combinations thereof.

Additionally, the composition may optionally also contain various additives, such as antioxidants; fillers and reinforcing agents having an average particle size less than or equal to 10 micrometers, such as, for example, silicates, TiO₂, fibers, glass fibers, glass spheres, calcium carbonate, talc, and mica; mold release agents; UV absorbers; stabilizers such as light stabilizers and others; lubricants; pigments; dyes; colorants; anti-static agents; foaming agents; blowing agents; metal deactivators, and combinations comprising one or more of the foregoing additives.

The components for the flexible composition can be combined under suitable conditions for the formation of an intimate blend, typically in a high shear mixing device such as an extruder or Banbury mixer.

There are several ways to make the composition by using equipment such as an extruder or kneader, typically at a temperature sufficient to allow melt mixing without substantial decomposition of any of the components. The components can be blended in a twin screw extruder for obtaining pellets of the composition at a temperature of 220° C. to 300° C. If using, for example, a 34 millimeter twin screw extruder (L/D ration of 40 made by Toshiba) with the screw speed from 200 to 600 rotations per minute (rpm) and through put from 20 to 100 kg/hr. Another way to make the composition is to separately feed the various components through different feeders in the throat.

In one embodiment, the composition may be prepared by melt mixing the components. The poly(arylene ether), impact modifier, polyolefin and optional flame retardant are melt mixed at a temperature greater than or equal to the glass transition temperature of the poly(arylene ether) but less than the degradation temperature of the polyolefin. After some or all the components are melt mixed, the molten mixture can be melt filtered through one of more filters having openings with diameters of 20 micrometers to 150 micrometers. Any suitable melt filtration system or device that can remove particulate impurities from the molten mixture may be used.

The resulting composition pellets were injection molded at the temperature of 230 to 300° C. into the appropriate size test bars for testing for tensile strength, tensile elongation, tensile strength and tensile elongation were conducted of modified ASTM D638 described above. One example of the molding machine can be Fanuc 2000i-200A made by Fanuc Inc. with injection speed of 25 to 150 mm/Sec and max injection pressure of 1000-2000 kgf/cm².

In preparing a coated wire, the composition in a molten state can be applied directly onto the surface of the conductive core by a suitable method such as extrusion coating to form a coated wire. The composition can also be applied to an insulating layer previously formed on a conductive core or onto the surface of a predetermined number of wires or cables (which can be coated or uncoated) to give a sheath layer that covers a multi wire cable. The thickness of the composition can vary and is typically determined by the end use of the coated wire or cable. In one embodiment the coating has a thickness of 0.03 mm to 0.3 mm.

In some embodiments it can be useful to dry the composition before extrusion coating the wire. Exemplary drying conditions are 70-85° C. for 2-5 hours. Additionally, the thermoplastic composition can be filtered prior to applying it to the conductive wire, typically through a filter having a mesh size of 30-300.

A color concentrate or masterbatch can be added to the composition prior to extrusion coating. When a color concentrate is used it is typically present in an amount less than or equal to 5 weight percent, based on the total weight of the composition. As appreciated by one of skill in the art, the color of the composition prior to the addition of color concentrate can impact the final color achieved and in some cases it can be advantageous to employ a bleaching agent and/or color stabilization agents. Bleaching agents and color stabilization agents are known in the art and are commercially available.

The processing temperature during extrusion coating is generally less than or equal to 320° C., or, more specifically, less than or equal to 300° C., or, more specifically, less than or equal to 280° C. The processing temperature is greater than or equal to 200° C. Additionally the processing temperature is greater than or equal to the softening temperature of the poly(arylene ether).

After extrusion coating the coated wire can be cooled using a water bath, water spray, air jets or a combination comprising one or more of the foregoing cooling methods. Exemplary water bath temperatures are 5 to 60° C. After cooling the coated wire is wound onto a spool or like device, typically at a speed of 50 meters per minute (m/min) to 1000 m/min.

In one embodiment the coating of the coated wire has tensile strength greater than or equal to 10 MegaPascals (MPa) and ultimate elongation greater than or equal to 100% as determined by UL1581. The coated wire can also have flame resistance of VW-1.

The wire can be used as electric wire without limitation, including, for example, wire for household electrical appliances, wire for electric power, wire for instruments, wire for data communication, wire for electric cars, as well as ships, and the like. Generally, the coated wire is used in low voltage applications such as direct current electrical cords, USB cable, audio/video cable and the like.

In some embodiments the thermoplastic composition may have a tensile strength greater than or equal to 7.0 megapascals and a tensile elongation greater than or equal to 50%, or, more specifically, greater than or equal to 70%, or, even more specifically, greater than or equal to 100%. Tensile strength and elongation are both determined by ASTM D638 on specimens having a thickness of 3.2 millimeters.

The flexible thermoplastic composition, coated wire, extrusion die are further illustrated by the following non-limiting examples. Examples described above illustrate but do not limit the present invention.

### EXAMPLES

### I. Examples of Die

### Example 1

In the die of Example 1, the exit passage 416 has a length B of 6 mm and an inner diameter (Y) of 5 mm. The wire coating passage 436 has a length A of 4 mm. The projection end 446 of the inner die 440 has a length C of 9 mm, and the projection end 446 has an outer diameter (X) of 4.4 mm and an inner diameter of 3.8 mm. In addition, when the inner die 440 is placed into the outer die 410, the length (D) of the projection end 446 lying outside the exit passage 416 has a length of 7 mm. Also, the taper of the conical inner space 412 of the outer die 410 is 55°, while the taper of the conical front end of the inner die 440 is 32°.

### Example 2

In the die of Example 2, the exit passage 416 has a length B of 6 mm and an inner diameter (Y) of 5.6 mm. The wire coating passage 436 has a length A of 6 mm. The projection end 446 of the inner die 440 has a length (C) of 9 mm, and the projection end 446 has an outer diameter (X) of 4.6 mm and an inner diameter of 3.8 mm. In addition, when the inner die 440 is placed into the outer die 410, the length (D) of the projection end 446 lying outside the exit passage 416 has a length of 9 mm. Also, the taper of the conical inner space 412 of the outer die 410 is 54°, while the taper of the conical front end of the inner die 440 is 31°.

### II. Composition Examples

The following examples were prepared using the materials listed in Table 1.

TABLE 1

| Component | Description |
|---|---|
| PPO.461V | A poly(2,6-dimethylphenylene ether) having an intrinsic viscosity of |
| | 0.46 dl/g as measured in chloroform at 25° C. and commercially |
| | available from General Electric. |
| RP6936 | Polystyrene-ethylene-butylene/styrene - polystyrene commercially |
| | available from Kraton Polymers Ltd under the tradename Kraton A |
| | Grade RP6936 |
| SB 2400 | Blend of polystyrene-poly(ethylene-butylene)-polystyrene, a |
| | copolymer of ethylene-propylene and mineral oil that is |
| | commercially available from Sumitomo Chemical under the |
| | tradename SB-2400. |
| LLDPE | Linear low density polyethylene commercially available from Nippon |
| | Unicar Co. Ltd under the tradename NUCG5381. |
| Melapur 200/70 | Melamine polyphosphate commercially available from Ciba |
| | Specialty Chemical Co. Ltd under the tradename Melapur 200. |
| Kisuma 5A | Magnesium hydroxide commercially available from Kyowa |
| | Chemical Industry Co. Ltd. under the trade name of Kisuma 5A. |
| Melamine-P | Melamine Pyrophosphate commercially available from Budenheim |
| | under the trade name of Budit 311 MPP, CAS No. 15541-60-3 |
| Indopol H50 | Polybutene commercially available from BP Chemical under the |
| | tradename Indopol H50 |
| RDP | Resorcinol bis-diphenylphosphate (CAS No. 57583-54-7) |
| BPADP | Bisphenol A disphosphate commercially available from Akzo Nobel |
| | Chemicals Inc under the tradename of Fyroflex BDP (CAS No. |
| | 181028-79-5) |

Compositions were made of formulations shown in Table 2. There are several ways to make the composition by using equipment such as an extruder or kneader, typically at a temperature sufficient to allow melt mixing without substantial decomposition of any of the components. The components can be blended in a twin screw extruder at a temperature of 220° C. to 300° C. If using, for example, a 34 millimeter twin screw extruder (L/D ration of 40 made by Toshiba) with the screw speed from 200 to 600 rotations per minute (rpm) and through put from 20 to 100 kg/hr. The compositions were made by combining the components except for RDP in the feedthroat of the extruder and the RDP was added to the extruder downstream of the feedthroat using a liquid injector. The composition can also be made by blending all the components including RDP together and feeding in the throat. Another way to make the composition is to separately feed the various components through different feeders in the throat. The resulting composition pellets were injection molded at the temperature of 230 to 300° C. into the appropriate size test bars for testing for tensile strength, tensile elongation, tensile strength and tensile elongation were conducted of modified ASTM D638 described above. One example of the molding machine can be Fanuc 2000i-200A made by Fanuc Inc. with injection speed of 25 to 150 mm/Sec and max injection pressure of 1500 kgf/cm². Results are also shown in Table 2.

The compositions shown in Table 2 were also extrusion coated to make coated wire and/or cables with different size or design. It is useful, some times it is a must to dry the composition pellets before extrusion coating the cable. Exemplary drying conditions are 60-90° C. for 2-20 hours or more specifically 70-85° C. for 3-8 hours. Additionally, the compositions were melted in a single screw extruder and could be filtered prior to applying it to the conductive wires, typically through a filter having a mesh size of 30-300. The diameters of the openings in the filter are 175 micrometers to 74 micrometers. For Table 2 examples, extruder size is 70 millimeter with compression ration of 2.5 and L/D of 25. The compositions were extruded onto a 0.8 mm×8 lines stranded copper wire to form a jacket/covering with a thickness of 0.4 mm to 1.1 mm for a total diameter of 4.7 to 6.0 millimeter. The coated wire or coating alone, as indicated by the test method, was tested for ultimate tensile strength and tensile elongation according to UL1581, and flame retardance performance according to UL 94 V(0) (Flammability tests were performed following the procedure of Underwriter's Laboratory Bulletin 94 entitled “Tests for Flammability of Plastic Materials, UL94”). Results are shown in Table 2.

TABLE 2
Compositions

| | Example 3 | Example 4 | Example 5 |
|---|---|---|---|
| PPO.461V | 16.27 | 23.00 | 28.00 |
| RP6936 | 29.51 | 24.00 | 21.00 |
| SB-2400 | | 19.00 | 17.00 |
| LLDPE | 17.71 | | |
| MELAPUR200/70 | 5.41 | 5.00 | 5.00 |
| Kisuma5A | 4.92 | 4.00 | 5.00 |
| Melamine-P | | | 8.00 |
| Indopol H50 | 7.38 | 9.00 | 8.00 |
| RDP | | | 8.00 |
| BPADP | 16.72 | 16.00 | |
| Total | 100.01 | 101.48 | 101.78 |
| LOI | | 25 | 26 |
| UL94 V(0) at thickness | V1, 3.2 | 3.2 | 4 |
| Tensile strength, Mpa | 18 | 15 | 14 |
| Tensile elongation, % | 230 | 250 | 205 |

### III. Wrinkle Testing Examples

Coated wires are extruded from the extrusion equipment comprising extrusion die of the invention. The composition used for the extrusion is the compositions shown in Table 2. The extrusion coating is conducted at a temperature of 200° C. to 300° C.

During extrusion coating a wire core through an extrusion coating equipment, the wire core is pulled by a retractor to continuously move through the wire-passing hole of the inner die to go through the projection end and then pass through the molding passage of the outer die. While the wire core is moving, the molten compositions shown in Table 2 are injected by a pressure into the material supplying passage, flows toward to the wire coating passage, and then into the molding passage with a speed of 23 m/min at the outlet to coat onto the outer surface of the wire core which is passing through the molding passage. Subsequently, the coated wire core continues to move through the molding passage to outside of the die while cooled and hardened, thus the manufacture of the wire is completed. In the molding passage, the composition which has been coated onto the surface of the wire core, which has an outer diameter Y, is further molded for a length A to be better coated onto the surface of the wire core. Results are shown in Table 3.

TABLE 3
Coated Wires

| | | |
|---|---|---|
| Example 6* | Example 7 | Example 8 |

Extrusion Die

| | | | | | New 1# die of the present | | | New 2# die of the present | | |
|---|---|---|---|---|---|---|---|---|---|---|
| | The Prior Art Die | | | | invention | | | invention | | |
| Outer | 5 | 5.6 | 5.8 | 6 | 5.4 | 5.6 | 6 | 5 | 5.2 | 5.6 |
| diameter Y | | | | | | | | | | |
| (mm) | | | | | | | | | | |
| Length A | 0 | 0 | 0 | 0 | 3 | 3 | 3 | 3 | 3 | 3 |
| (mm) | | | | | | | | | | |
| Example 3 | Wrinkle | N/A | N/A | Wrinkle | No | No | No | No | No | N/A |
| | | | | | wrinkle | wrinkle | wrinkle | wrinkle | wrinkle | |
| Example 4 | Wrinkle | Wrinkle | N/A | N/A | N/A | No | N/A | N/A | N/A | N/A |
| | | | | | | wrinkle | | | | |
| Example 5 | N/A | No | No | N/A | N/A | No | No | No | No | N/A |
| | | wrinkle | wrinkle | | | wrinkle | wrinkle | wrinkle | wrinkle | |

Notes:
*Comparative Example
N/A represents no results available;
Wrinkle: wrinkles including Type I and Type II wrinkles
No Wrinkle: No Type I and Type II wrinkles

As can be seen from results of Examples 3 and 4, when the prior art die is used to manufacture a coated wire with a thermoplastic composition comprising poly(arylene oxide), e.g., Noryl® commercially available from GE Electric, it has been found that when thus manufactured wires are bent, they easily develop wrinkles on the inner side of the bent portion, as shown in FIG. 4(b). The extrusion die of the invention demonstrates good applicability in extruding replacement materials, especially for a composition comprising poly(arylene ether). As mentioned before, the wrinkles may reduce the adhering strength between the wire core and coating and/or between the different coatings, thereby leave the wires deteriorated.

It is apparent from results of Examples that the coated wires comprising the composition of the invention made by the method of the invention have improved in structural features, i.e., reduction in wrinkles on the covering of the coated wire.

It is clear from the above results that the die and the coated wire of the invention provide improved mechanical processability and durability for wires coated with non-halogenated compositions. As mentioned before, the wrinkle issue is critical issue for the coated wire useful in, e.g., telephone cable and telecommunication cable since wrinkles may reduce the adhering strength between the wire core and coating and/or between the different coatings, thereby leave the wires deteriorated. By the invention, the wrinkle issue can be removed any more.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

1. An extrusion die comprising an inner die (440) and an outer die (410),
wherein the inner die (440) comprises a wire core passing space (442) and a projection end (446) having a length (C);
wherein the outer die (410) comprises an inner space (412) and an exit passage (416);
wherein the projection end (446) of the inner die (440) is positioned at least partially within the inner space (412) and exit passage (416) of the outer die (410) to form a wire coating passage (432) and a molding passage (436).

2. The die of claim 1, wherein the average ratio of the length (A) of the molding passage (436) to the average inner width (Y) of the exit passage (416) is 0.2 to 3.

3. The die of claim 2, wherein the average ratio of the average outer width (X) of the projection end (446) of the inner die (440) to the average inner width (Y) of the exit passage (416) of the outer die (410) is 0.4 to 0.95.

4. The die of claim 1, wherein the projection end (446) of the inner die (440) has a length (D) that is positioned outside the exit passage (416) of the outer die (410).

5. The die of claim 4, wherein the average ratio of length (D) to the average outer width (X) of projection end (446) of the inner die (440) is 0.2 to 3.

6. The die of claim 1, wherein the projection end (446) of the inner die (440) has a cylindrical shape.

7. The die of claim 6, wherein the average outer width (X) is the average outer diameter of the projection end (446).

8. The die of claim 1, wherein the exit passage (416) of the outer die (410) has a cylindrical shape.

9. The die of claim 8, wherein the average inner width (Y) is the average inner diameter of the exit passage (416).

10. The die of claim 1, wherein the die comprises more than one inner die and more than one outer die.

11. An extrusion equipment comprising a die according to the claim 1.

12. A method for coating a wire core comprising extrusion coating a thermoplastic composition onto a wire core wherein the extrusion coating comprises use of a die according to the claim 1.

13. A method for reducing wrinkles on the covering of a coated wire, wherein said method comprises extrusion coating a thermoplastic composition onto a wire core wherein the extrusion coating comprises use of a die according to the claim 1.

14. The method of claim 13, wherein the thermoplastic composition comprises by weight of the total composition (i) 10% to 50% of a poly(arylene ether); (ii) 5% to 25% of a polyolefin; and (iii) 15% to 45% of an impact modifier.

15. The method of claim 14, wherein the composition further comprises (iv) 10% to 40% of a flame retardant additive composition.

16. The method of claim 15, wherein the composition comprises by weight of the total composition,
(i) 10% to 50% of a poly(arylene ether);
(ii) 5% to 25% of a polyolefin;
(iii) 15% to 45% of an impact modifier; and
(iv) 10% to 40% a flame retardant additive composition comprising by weight of the flame retardant additive composition:
3% to 20% of a phosphoric acid salt selected from the group consisting of melamine phosphate, melamine pyrophosphate, melamine orthophosphate, diammonium phosphate, mono-ammonium phosphate, phosphoric acid amide, melamine polyphosphate, ammonium polyphosphate, polyphosphoric acid amide, and combinations of two or more of the foregoing;
3% to 15% of a metal hydroxide; and
3% to 15% of an organic phosphate.

17. The method of claim 16, wherein the composition further comprises (v) less than 10% of a plasticizer.

18. The method of claim 17, wherein the plasticizer is selected from liquid polybutene, mineral oil and combinations thereof.

19. A method of coating a wire core comprising the steps of:
a) melting a thermoplastic composition to form a melt thermoplastic composition which comprises by weight of the total composition: (i) 10% to 50% of a poly(arylene ether); (ii) 5% to 25% of a polyolefin; and (iii) 15% to 45% of an impact modifier;
(b) optionally filtering the melt thermoplastic composition to form a filtered composition;
(c) coating the filtered composition onto a wire core; and
(d) molding the coated wire for a length (A).

20. A method of claim 19, wherein the length (A) is from 2 to 30 mm.

21. A method of claim 20, wherein the length (A) is from 2 to 12 mm.

22. The method of claim 19, wherein coated wire has an average outer width (Y).

23. The method of claim 20, wherein the average ratio of the length (A) to the average outer width (Y) is 0.2 to 3.

24. A method of coating a wire core by a die of claim 1 comprising the steps of
(a) melting a thermoplastic composition to form a melt thermoplastic composition which comprises by weight of the total composition: (i) 10% to 50% of a poly(arylene ether); (ii) 5% to 25% of a polyolefin; and (iii) 15% to 45% of an impact modifier;
(b) optionally filtering the melt thermoplastic composition to form a filtered composition;
(c) coating the filtered composition onto a wire core in the wire coating passage (432); and
(d) molding the coated wire in the molding passage (436).

25. The method of claim 24, wherein the composition further comprises (iv) 10% to 40% of a flame retardant additive composition.

26. The method of claim 25, wherein the composition comprises by weight of the total composition
(i) 10% to 50% of a poly(arylene ether);
(ii) 5% to 25% of a polyolefin;
(iii) 15% to 45% of an impact modifier; and
(iv) 10% to 40% of a flame retardant additive composition comprising by weight of the flame retardant additive composition
3% to 20% of a phosphoric acid salt selected from the group consisting of melamine phosphate, melamine pyrophosphate, melamine orthophosphate, diammonium phosphate, mono-ammonium phosphate, phosphoric acid amide, melamine polyphosphate, ammonium polyphosphate, polyphosphoric acid amide, and combinations of two or more of the foregoing;
3% to 15% of a metal hydroxide; and
3% to 15% of an organic phosphate.

27. The method of claim 26, wherein the composition further comprises (v) less than 10% of a plasticizer.

28. The method of claim 27 wherein the plasticizer is selected from liquid polybutene, mineral oil and combinations thereof.

29. A coated wire comprises a wire core and a covering comprising a thermoplastic composition,
wherein the coated wire is made by a method of claim 12;
wherein the thermoplastic composition comprises by weight of the total composition: (i) 10% to 50% of a poly(arylene ether); (ii) 5% to 25% of a polyolefin; and (iii) 15% to 45% of an impact modifier.

30. A coated wire comprising a wire core and a covering comprising a thermoplastic composition,
wherein the coated wire is made by a method of extrusion coating a wire core by a die of claim 1;
wherein the thermoplastic composition comprises by weight of the total composition: (i) 10% to 50% of a poly(arylene ether); (ii) 5% to 25% of a polyolefin; and (iii) 15% to 45% of an impact modifier.

31. The coated wire of claim 29, wherein the composition further comprises (iv) 10% to 40% of a flame retardant additive composition.

32. The coated wire of claim 31, wherein the composition comprises by weight of the total composition
(i) 10% to 50% of a poly(arylene ether);
(ii) 5% to 25% of a polyolefin;
(iii) 15% to 45% of an impact modifier; and
(iv) 10% to 40% of a flame retardant additive composition comprising by weight of the flame retardant additive composition
3% to 20% of a phosphoric acid salt selected from the group consisting of melamine phosphate, melamine pyrophosphate, melamine orthophosphate, diammonium phosphate, mono-ammonium phosphate, phosphoric acid amide, melamine polyphosphate, ammonium polyphosphate, polyphosphoric acid amide, and combinations of two or more of the foregoing;
3% to 15% of a metal hydroxide; and
3% to 15% of an organic phosphate.

33. The coated wire of claim 32, wherein the composition comprises by weight of the total composition wherein the composition further comprises (v) less than 10% of a plasticizer.

34. The coated wire of claim 29, wherein the coated wire has reduced wrinkles on the covering and the wrinkles have a ratio of wrinkle depth to outer diameter of the coated wire of less than 1 when the coated wire is bent.

35. The coated wire of claim 34, wherein the ratio is 0.25 to 1 for Type I wrinkles.

36. The coated wire of claim 34, wherein the ratio is less than 0.25 for Type II wrinkles.

37. The coated wire of claim 34 wherein the wire is bent to have a bending angle of less than 120 degree.

38. The coated wire of claim 37 wherein the bending angle is from 60 degree to 90 degree.

39. The coated wire of claim 34, wherein the coated wire has a cylindrical shape.

40. The coated wire of claim 39, wherein the coated wire has an outer diameter of from 2 mm to 4 cm.

41. The coated wire of claim 40, wherein the coated wire has a diameter of from 2 mm to 1 cm.

42. The coated wire of claim 34, wherein the coated wire has wrinkles of less than 2 mm in depth.

43. The coated wire of claim 34, wherein the coated wire has wrinkles of less than 800 microns in depth.

44. The coated wire of claim 29, wherein the coated wire is free of Type I wrinkles when the coated wire is bent.

45. The coated wire of claim 29, wherein the coated wire is free of Type II wrinkles when the coated wire is bent.

46. The coated wire of claim 29, wherein the coated wire is free of Type I and Type II wrinkles when the coated wire is bent.

47. A method of testing wrinkle on surface of coated wire comprising steps of:
(i) setting a bending length from point 1 to point 2 on a coated wire;
(ii) bending the wire to bring the point 1 and point 2 being contact;
(iii) determining a bending angle α between [AB] and [AC] wherein point A is located at the top of the bent samples while the distance between points B and C defines the maximum width of the bent samples; and
(iv) measuring wrinkles in depth from lowest point of surface of the coated wire to the top of the surface of the coated wire at the bending angle;
wherein a ratio of the bending length to outer diameter of a coated wire at a range of from 5 to 20; and
wherein the bending angle is of from 50 to 120 degree.
